(19) United States
(12) Patent Application Publication
(10) Pub. No.: US 2005/0240318 A1
(43) Pub. Date: Oct. 27, 2005

(54) Mobile terminal server

(76) Inventors: Yasuhiro Naoi, Tokyo (JP); Shigetoshi Yokoyama, Tokyo (JP); Koji Miyata, Tokyo (JP); Kazutoshi Takano, Tokyo (JP); Kazuaki Shirakashi, Tokyo (JP); Yusaku Nakajima, Tokyo (JP)

Correspondence Address: HONIGMAN MILLER SCHWARTZ AND COHN LLP, 32270 TELEGRAPH RD, SUITE 225, BINGHAM FARMS, MI, 48025-2457, US

(21) Appl. No.: 10/513,102

(22) PCT Filed: Mar. 26, 2003
(86) PCT No.: PCT/JP03/03717

§ 371 Date: Jun. 3, 2005

(30) Foreign Application Priority Data
Apr. 30, 2002 (JP) 2002-129243
May 21, 2002 (JP) 2002-145647
Aug. 14, 2002 (JP) 2002-236299

(51) Int. Cl. G05D 1/00

(52) U.S. Cl. 701/1

(57) ABSTRACT

A server provides information to be executed by a mobile terminal to the mobile terminal. The server and the mobile terminal are configured so that an instant message (IM) can be used each other. The mobile terminal notifies the server of information indicating a user status detected by user status detection based on IM technique. The server and/or mobile terminal decide information to be provided to the mobile terminal from the server based on the detected user status. Also, the server detects a self-status by status detection based on IM technique, and decides information to be provided to the mobile terminal based on this. At the time of executing information provided from the server, the mobile terminal controls the execution based on the detected user status.

### TECHNICAL FIELD

The present invention relates to a mobile terminal server that is suitable for providing information to a mobile terminal such as a mobile communication terminal and the like.

### BACKGROUND OF THE INVENTION

The mobile terminals such as a cellular phone are widely used. Such a mobile terminal has been highly sophisticated to allow connection to, for example, the Internet, so that the range of use is extended. Moreover, the miniaturization of the apparatus has progressed to improve portability. Accordingly, even the mobile terminal having high portability can enjoy the same service as that of the network use by an information processing apparatus such as a personal computer and the like.

However, the aforementioned mobile terminal is inferior in the hardware performance to the personal computer. Also, even in the case where the same service is used, complicated operations are sometimes required because of the small size, so that usability is reduced in some cases.

### SUMMARY OF THE INVENTION

In view of the above problems in the conventional art, the present invention has an object to provide a mobile terminal server that improves usability.

In order to attain the above object, a mobile terminal server according to a first aspect of the present invention is a mobile terminal server (100) that provides predetermined information to a mobile terminal (200) via a communications network (10), comprises:
a status information obtaining section (110) that obtains each of status information indicating a status of the mobile terminal server (100), a status of the mobile terminal (200), and a status of a user of the mobile terminal;
an execution information storing section (140) that stores execution information of multiple kinds executed by the mobile terminal (200);
a provision object deciding section (110) that decides execution information to be provided to a predetermined mobile terminal (200) among execution information stored in the execution information storing section (140); and
an execution information providing section (110) that provides execution information decided by the provision object deciding section (110) to the predetermined mobile terminal (200), and
wherein the provision object deciding section (110) decides execution information to serve as a provision object based on each status information obtained by the status information obtaining section (110).

The mobile terminal server further comprises a user information storing section (130) that stores user information relating to a user of the mobile terminal (200); and
a user information update detecting section (110) that detects an update of user information stored in the user information storing section (130), and
if the user information update detecting section (110) detects an update of user information, the provision object deciding section (110) decides execution information to be provided to the mobile terminal of the user based on the updated user information.

The user information storing section (130) stores job priority information indicating priority of job to be executed by the mobile terminal (200), and
the mobile terminal server further comprises a terminal control section (110) that causes the mobile terminal (200) to execute the job according to the priority indicated by the job priority information.

The user information storing section (130) further stores status information indicating execution status of a job to be executed by the mobile terminal (200); and
the terminal control section (110) includes a first determining section (110) that responds to an execution request of a job supplied from an external section to determine whether the mobile terminal is executing a job with a lower priority than a request job requested to be executed by the execution request using the job priority information and the status information, and
a first control section (110) that controls the mobile terminal to interrupt execution of the lower job and execute the request job if determining that the mobile terminal is executing the low job.

In this case, the first control section (110) responds to an end signal indicating an end of the request job supplied from the mobile terminal to cause the mobile terminal to restart execution of the lower job that is interrupted to be executed.

In the above mobile terminal server,
the terminal control section (110) further includes:
a second determining section (110) that responds to an execution request of a job supplied from an external section to determine whether the mobile terminal is executing a job with a higher priority than a request job requested to be executed by the execution request using the job priority information and the status information; and
a second control section (110) that responds to an end signal indicating an end of the higher job supplied from the mobile terminal and causes the mobile terminal to execute the request job if determining that the mobile terminal is executing the high job.

The user information storing section (130) stores information indicating folding status of multiple mobile terminal (200), and
the mobile terminal server further comprises a transmitting section that responds to an unfold signal supplied from one mobile terminal (200) and indicating that the relevant mobile terminal (200) is unfolded, and obtains folding status of the other mobile terminal (200) designated as folding status notifying object by a user of the relevant mobile terminal (200), and transmits the result to one mobile terminal (200).

In this case,
the transmitting section responds to the unfold signal and a fold signal supplied from one mobile terminal (200) and indicating that the relevant mobile terminal (200) is folded, and transmits information indicating folding status of one mobile terminal (200) to another mobile terminal (200) possessed by a user, who designates one mobile terminal (200) as folding status notifying object.

Moreover, the execution information storing section (140) stores information divided into multiple genres, and
the transmitting section responds to an unfold signal supplied from the mobile terminal (200) and indicating that the relevant mobile (200) is unfolded, and transmits information of a predetermined genre to the relevant terminal (200) from information stored in the execution information storing section (140).

In order to attain the above object, a program according to a second aspect of the present invention causes a computer to function as the above described mobile terminal server.

In order to attain the above object, a program according to a third aspect of the present invention causes a computer to function as a mobile terminal (200) that receives provision of execution information to be executed by the computer from a mobile terminal server (100) connected via a communications network (10), comprising:
a user status detecting section (210) that sequentially detects a current status of a user of the computer;
a user information recording section (230) that prerecords user information relating to the user; a user information notifying section (210) that sequentially notifies the mobile terminal server (100) of a status information indicating the user status and the user information;
an input section (260) that inputs an instruction from the user;
an execution information requiring section (210) that requires the mobile terminal server (100) to provide execution information via the communications network (10) based on the instruction input to the input section (260); an execution information receiving section (210) that receives information notified by the user information notifying section (210) or execution information decided based on a request by the information requesting section (210) via the communications network (10);
a received information storing section (250) that stores execution information received by the execution information receiving section (210);
an execution information executing section (210) that executes execution information stored in the received information storing section (250); an input information storing section (230) that stores the input information to be associated with the execution information if execution by the execution information executing section (210) requests an input of predetermined information to the input section (260);
an input information transmitting section (210) that transmits input information stored by the input information storing section (230) to the mobile terminal server (100); and
an execution control section (210) that controls execution of information by the execution information executing section (210) based on the user status detected by the status detecting section (210).

### BRIEF DESCRIPTION OF DRAWINGS

FIG. 1 is a view illustrating a configuration of a mobile network system according to a first embodiment of the present invention;

FIG. 2 is a block diagram illustrating a configuration of a server illustrated in FIG. 1;

FIG. 3 is a view illustrating an example of information stored in a user information database illustrated in FIG. 2;

FIG. 4 is a view illustrating an example of information stored in a provision information database illustrated in FIG. 2;

FIG. 5 is a view illustrating an example of information stored in a transferred information database illustrated in FIG. 2;

FIG. 6 is a block diagram illustrating a configuration of a mobile terminal according to a first embodiment of the present invention;

FIG. 7 is a flowchart explaining “form provision preparation processing” and “form request processing” according to a first embodiment of the present invention;

FIG. 8 is a flowchart explaining “object request decision processing (1)” executed by a mobile terminal during the “form request processing” illustrated in FIG. 7;

FIG. 9 is a flowchart explaining “object request decision processing (2)” executed by a mobile terminal during the “form request processing” illustrated in FIG. 7;

FIG. 10 is a flowchart explaining “object request decision processing (3)” executed by a mobile terminal during the “form request processing” illustrated in FIG. 7;

FIG. 11 is a flowchart explaining “provision form decision processing” executed by a server duiring the “form provision preparation processing” illustrated in FIG. 7;

FIG. 12 is a flowchart explaining “interruption processing” executed by a server during the “form provision preparation processing” illustrated in FIG. 7;

FIG. 13 is a flowchart explaining “form provision processing” executed by a server after “form provision preparation processing” illustrated in FIG. 7, and “form reception processing” executed by a mobile terminal after “form request processing” illustrated in FIG. 7;

FIG. 14 is a flowchart explaining “form execution processing” executed by a mobile terminal after “form reception processing” illustrated in FIG. 13;

FIG. 15 is a flowchart explaining “continuous provision processing” executed by a server after “form execution processing” in FIG. 14;

FIG. 16 is a flowchart explaining “no-response confirmation processing” according to a first embodiment of the present invention;

FIG. 17 is a flowchart explaining “no-reply notice form execution processing” executed by a mobile terminal after “no-response confirmation processing” illustrated in FIG. 16;

FIG. 18 is a view illustrating an example of a display screen displayed by a mobile terminal during “no-reply notice form execution processing” illustrated in FIG. 17;

FIG. 19A is a view illustrating an example of a “status information management table” stored in a user information DB according to a second embodiment;

FIG. 19B is a view illustrating an example of a “waiting job list” according to a second embodiment;

FIG. 20 is a flowchart explaining “job start processing” according to a second embodiment;

FIG. 21 is a flowchart explaining “first terminal control processing” according to a second embodiment;

FIG. 22 is a flowchart explaining “job termination processing” according to a second embodiment;

FIG. 23 is a flowchart explaining “second terminal control processing” according to a second embodiment;

FIG. 24 is a view illustrating an example of a “distribution order table” stored in a user information DB;

FIG. 25 is a flowchart explaining “third terminal control processing” according to a second embodiment;

FIG. 26 is a view illustrating an example of a “user information table” stored by a user information DB according to a third embodiment;

FIG. 27 is a flowchart explaining “service start processing” according to a third embodiment;

FIG. 28 is a flowchart explaining “status change processing” according to a third embodiment;

FIG. 29 is a view illustrating an example of a “user information table” stored by a user information DB according to a fourth embodiment;

FIG. 30 is a flowchart explaining “information provision processing” according to a fourth embodiment;

FIG. 31 is a flowchart explaining “service stop processing” according to a fourth embodiment; and

FIG. 32 is a flowchart explaining “information transmission processing” according to a fourth embodiment.

### DETAILED DESCRIPTION OF THE INVENTION

### First Embodiment

The following explains an embodiment of the present invention with reference to the drawings. This embodiment explains a mobile network system that provides information to a mobile terminal 200 using an IM (Instant Message) function of the mobile terminal 200 such as a cellar phone and the like.

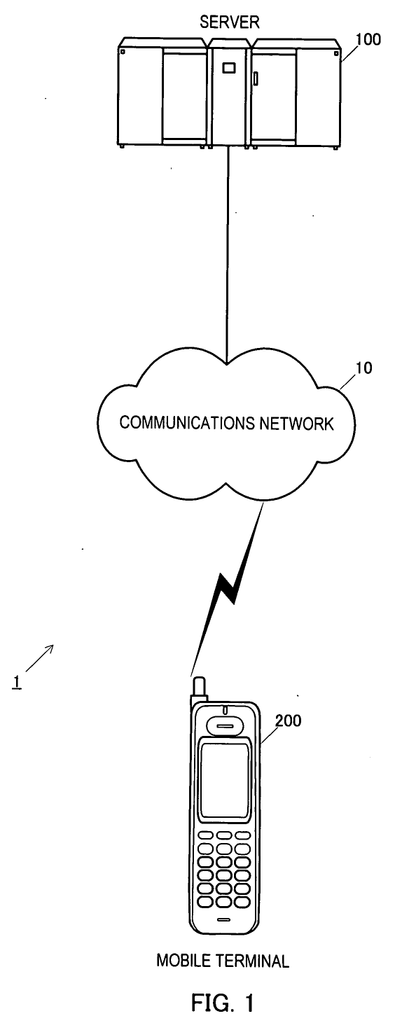

FIG. 1 is a view illustrating a configuration of the mobile network system according to the embodiment of the present invention. As illustrated in the figure, a mobile network system 1 according to the present embodiment includes a server 100 and a mobile terminal 200 that are connected to each other via a communication network 10.

Here, the communication network 10 is a communication network that performs information transmission using a predetermined communication protocol such as the Internet (for example, TCP/IP (Transmission Control Protocol/Internet Protocol) and the like).

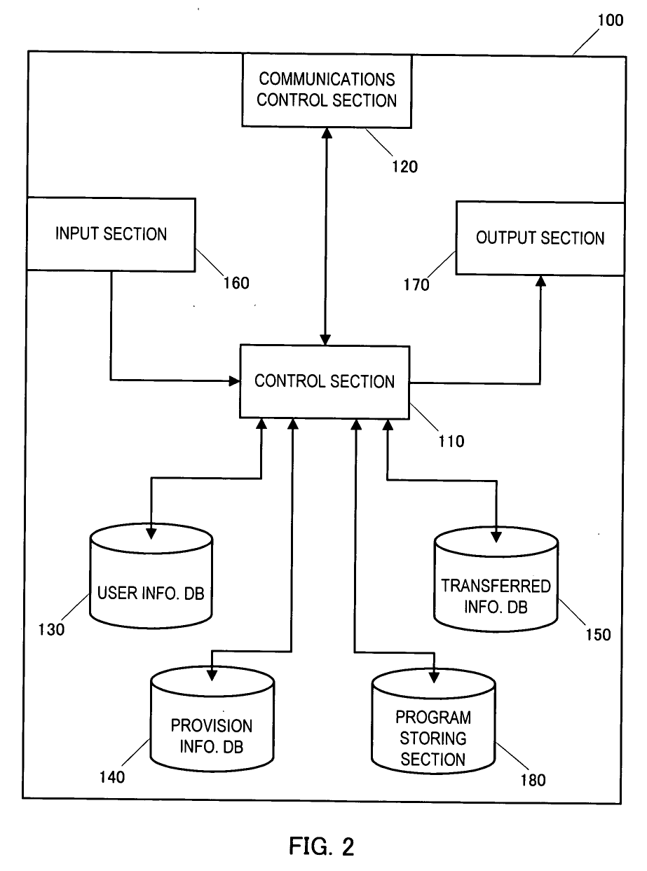

The server 100 includes a predetermined computer apparatus such as a main frame, a workstation, and the like, and executes the respective processing to be described later to provide information to the mobile terminal 200. A configuration of the server 100 is explained with reference to FIG. 2. Additionally, in this embodiment, it is assumed that the server 100 functions as a server that provides a so-called instant message (hereinafter referred to as “IM”) service in which an immediate and simple message exchange with the other mobile terminal is executed. Accordingly, it is assumed that the server 100 includes predetermined programs and apparatuses that are necessary for providing the IM service and that the respective processing executed between the service 100 and the mobile terminal 200 to be described later is performed using the method and technique for these IM services.

FIG. 2 is a block diagram illustrating a configuration of the server 100. As illustrated in this figure, the server 100 includes a control 110, a communications control section 120, a user information database 130, a provision information database 140, a transferred information database 150, an input section 160, an output section 170, and a program storing section 180.

The control section 110 includes, for example, a CPU (Central Processing Unit), and controls the respective sections of the server 100 and executes a predetermined operation processing, thereby implementing the respective processing to be described later.

The communications control section 120 includes a predetermined communication device such as a router and connects the server 100 to a communications network 10 to control information communications between the server 100 and the mobile terminal 200.

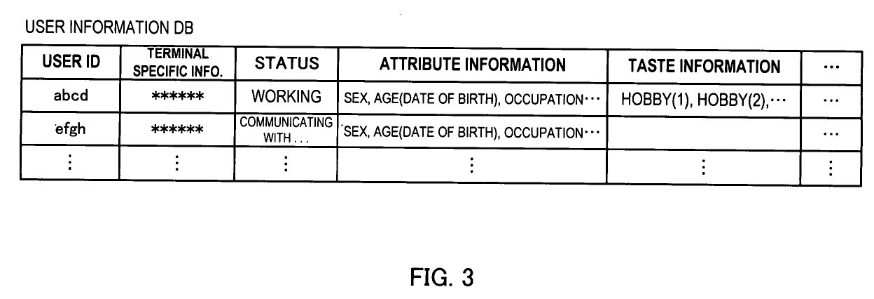

The user information database 130 includes a rewritable storage device such as a hard disk device, and preregisters information of a user, who uses information provision service by the mobile network system 1 according to the present embodiment, namely, a user of the mobile terminal 200. Additionally, information recorded on the user information database 130 is registered by the user at the time of starting to use the information provision service according to the present mobile network system 1. Thereafter, a predetermined one of user information recorded on a user information storing section 230 of the mobile terminal 200 to be described later is transmitted as the need arises, thereby updating user information recorded on the user information database 130 as required. FIG. 3 illustrates an example of information recorded on the user information database 130.

As illustrated in the figure, in the user information database 130, a record is created for each user ID allocated to each user, and terminal specific information (for example, IP address, e-mail address, telephone number, etc) that specifies the mobile terminal 200 used by the relevant user, status information indicating a current status of the relevant user, attribute information indicating attributes (sex, age, date of birth, occupation, etc) of the relevant user, and taste information indicating user's taste are recorded on the respective records. In this case, status information is information that indicates each user status detected by status detection by the IM technique and that is obtained from each mobile terminal 200 at any time. Information indicating, for example, “at work”, “on shopping”, “in communication with the other user”, is recorded as status information. The status information is generated if information is set and input to the mobile terminal 200 by the user and if information (for example, communication state, communication terminal, end of program, power OFF, etc) is detected by the mobile terminal 200, and the result is transmitted to the server 100 as required. The transmitted status information is recorded on the user information database 130 and is updated as required.

The provision information database 140 includes a rewritable storage device such as a hard disk device and stores information provided to the mobile terminal 200 used by a registered user. Additionally, in the present embodiment, information recorded on the provision information database 140 is information that is obtained (downloaded) by the mobile terminal 200 and that is executed by a predetermined program (hereinafter referred to as “terminal program”) mounted on the mobile terminal, for example, a page that forms a questionnaire service, and a page that forms an Electronic Commerce (hereinafter referred to as “EC”) site. These information items are prepared for each predetermined unit (each page unit), and they are described in such a language that has a dynamic association therebetween (for example, HTML (Hyper Text Markup Language)). For example, association as to which questionnaire page should be next presented is performed based on the contents of a reply to a certain questionnaire. In this case, though one that is presented to the user is simply an input form that displays a questionnaire item and a reply input field, the terminal program interprets the description language to perform the dynamic association based on information input as a reply. In the present embodiment, information, which forms a predetermined input form apparently if being executed, is provided to the mobile terminal 200, and this is hereinafter called as “form (information).”

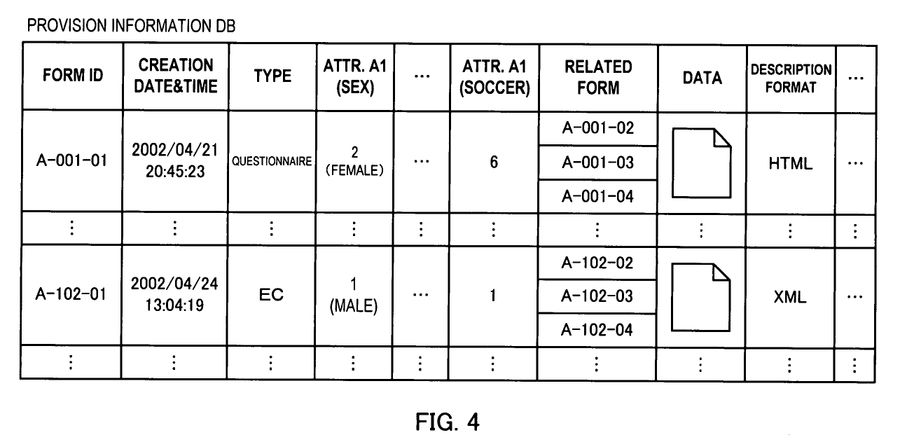

FIG. 4 illustrates an example of information recorded on the provision information database 140. As illustrated in the figure, in the provision information database 140, a record is created for each ID allocated to each form, and information, which indicates the type of the relational form (by questionnaire, EC, etc.), an attribute of user as a presenting object, a form ID of the associated form, the relevant data and its description language and the like, is recorded on reach record. In this case, “attribute” recorded on the provision information database 140 corresponds to “attribute information” and “taste information” recorded on the user information database 130. Namely, for example, even if the questionnaire has the same object, a form whose questionnaire item is different depending on the attribute and taste of the respondent (user of the mobile terminal 200) is prepared to present appropriate information.

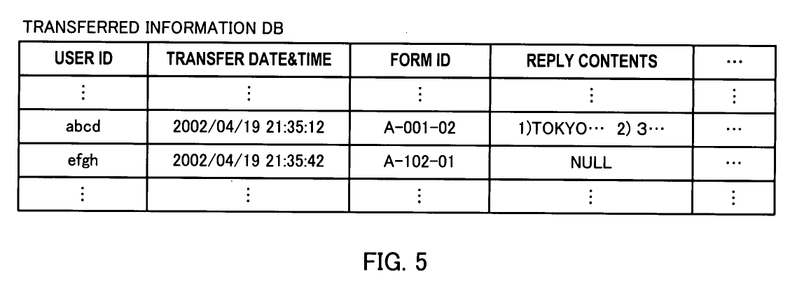

The transferred information database 150 includes a rewritable storage device such as a hard disk device and stores information relating to the form transferred to the mobile terminal 200 from the server 100. FIG. 5 illustrates an example of information recorded on the transferred information database 150. As illustrated in the figure, in the transferred information database 150, there is stored information indicating a user ID showing a user at a transfer destination, date and time of transfer, a form ID showing the transferred form, and the contents replied using the transferred form.

The input section 160 includes a predetermined input device such as a keyboard, a pointing device and the like, and is used to input an instruction to the control section 110 and input information to each database.

The output section 170 includes a predetermined output device such as a display device, and outputs a processing result of the control section 110.

The program storing section 180 includes a storage device such as a hard disk device, a semiconductor storage device and the like, and stores an operation program of the server 100. Each processing to be describe later is implemented if the control section 110 reads a predetermined operation program from the program storage section 180.

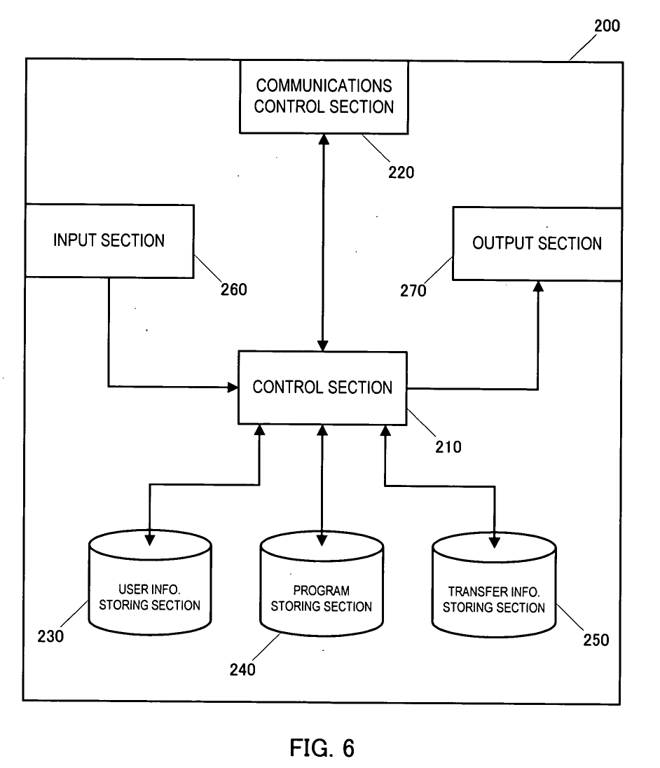

An explanation is next given of a configuration of the mobile terminal 200. The mobile terminal 200 includes an information mobile terminal having a predetermined computer apparatus such as a mobile communication terminal (cellular phone, PHS (Personal Handyphone System) etc.), a PDA (Personal Data Assistance) and the like, and is configured so that information (form) can be received from the server 100 via the communications network 10. In the present embodiment, it is assumed that the mobile terminal 200 is configured so that at least the IM service is made available between the mobile terminal 200 and the server 100 via the communications network 10. In other words, it is assumed that a predetermined program for using the IM service is installed onto the mobile terminal 200 and that each processing executed between the server 100 and the mobile terminal 200 is performed using the method and technique for the IM service. The configuration of the mobile terminal 200 is explained with reference to FIG. 6.

As illustrated, the mobile terminal 200 includes a control section 210, a communications control section 220, a user information storing section 230, a program storing section 240, a transfer information storing section 250, an input section 260, and an output section 270.

The control section 210 includes, for example, a CPU (Central Processing Unit) and implements each processing to be described later by executing a predetermined operation program stored in the program storing section 240 to be described later.

The communications control section 220 includes a predetermined communications apparatus (including a circuit, module, etc.) having, for example, a router, a TA (terminal Adapter), a modem, or an antenna device, and the mobile terminal 200 and the communications network 10 are connected to perform information communication with the server 100.

The user information storing section 230 includes a rewritable storage device such as a hard disk device, an EEPROM (Electrically Erasable Programmable Read Only Memory), a flash memory and various kinds of storage media, or a storage medium, and prerecords information relating to the user of the mobile terminal 200. Information recorded on the user information storing section corresponds to at least “attribute information” and “taste information” recorded on the user information database 130 of the server 100 illustrated in FIG. 3. Namely, a predetermined one (one that may be disclosed to the server 100) of information recorded on the user information storing section 230 of the mobile terminal 200 is transmitted to the server 100 at any time, so that information is updated and recorded on the user information database 130 of the server 100.

The program storing section 240 includes a rewritable storage device such as a hard disk device, an EEPROM (Electrically Erasable Programmable Read Only Memory), a flash memory and various kinds of storage media, or a storage medium, and records a predetermined operation program (a program for using the IM service and a program that executes the form transferred from the server 100 and the like). Additionally, in order to implement each processing to be described later in the present embodiment, each operation program executed by the control section 210 of the mobile terminal 200 is hereinafter called “terminal program.”

The transfer information storing section 250 includes a rewritable storage device such as a hard disk device, an EEPROM (Electrically Erasable Programmable Read Only Memory), a flash memory and various kinds of storage media, or a storage medium, and stores the form transferred from the server 100.

The input section 260 includes a predetermined input device such as a keyboard, a pointing device and the like, and is used to input an instruction to the control section 210 and input information to the user information storing section 230, and input to the executed form.

The output section 270 includes a predetermined output device such as a display device, and outputs a processing result (execution result of the received form, etc.) of the control section 210.

An explanation is next given of each processing that is executed by the server 100 and the mobile terminal 200 in the mobile network system 1 according to the present embodiment with reference to the drawings.

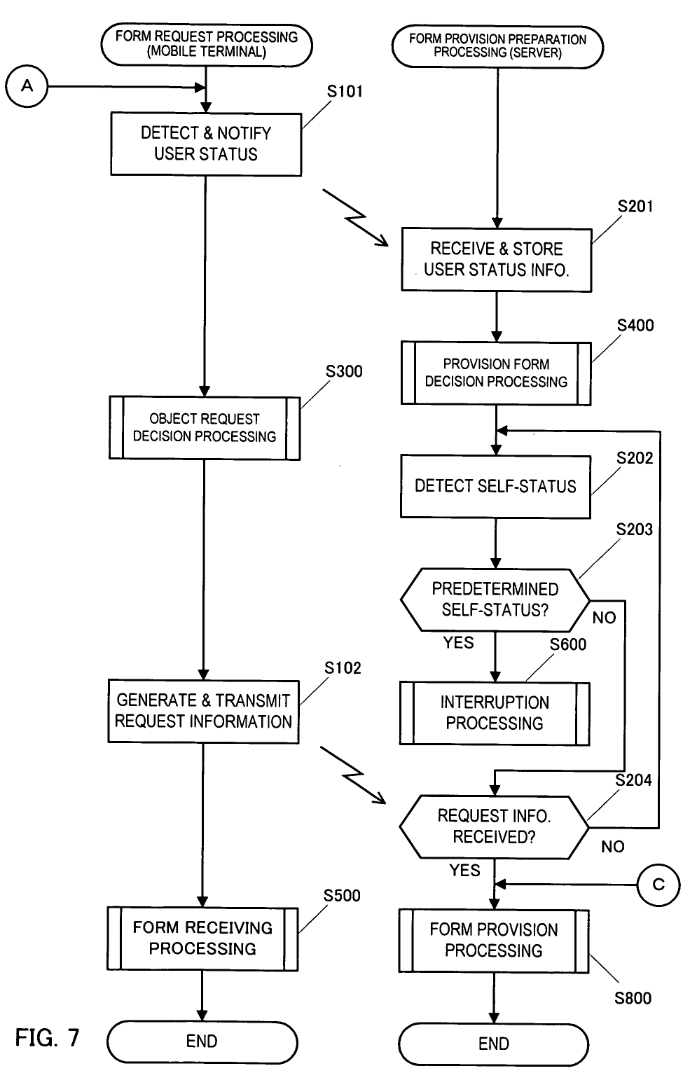

An explanation is first given of form request processing (operation of the mobile terminal 200) and form provision preparation processing (operation of the server 100) according to the present embodiment with reference to a flowchart illustrated in FIG. 7.

First, if the control section 210 of the mobile terminal 200 executes a terminal program stored in the program storing section 240, the control section 210 detects a user status for each predetermined time period as required (step S101). Namely, the user operates the input section 260 to detect the status of the mobile communication terminal 200 relating to the communication by IM such as detection on “whether communication with the other user is performed by IM”, “who is a communication partner if the communication is being executed”, “whether the form is being executed”, “whether the terminal program is ended”, and “whether power of the mobile terminal 200 is turned OFF (if the mobile terminal 200 is a mobile communication terminal) in addition to detection on whether a predetermined status is set, thereby detecting the result as a user status (availability/unavailability of communication, etc.). The control section 210 notifies the server 100 of information (hereinafter referred to as “user status information”) indicating the detected user status via the communications control section 220. Additionally, at this time, user status information to which predetermined terminal specific information is added is notified.

In the server 100, if the communications control section 120 receives user status information from the mobile terminal 200, the control section 110 specifies the corresponding record from the user information database 130 based on the terminal specific information added to the relevant user status information, and records the received user status information in a “status information” field of the corresponding record (step S201).

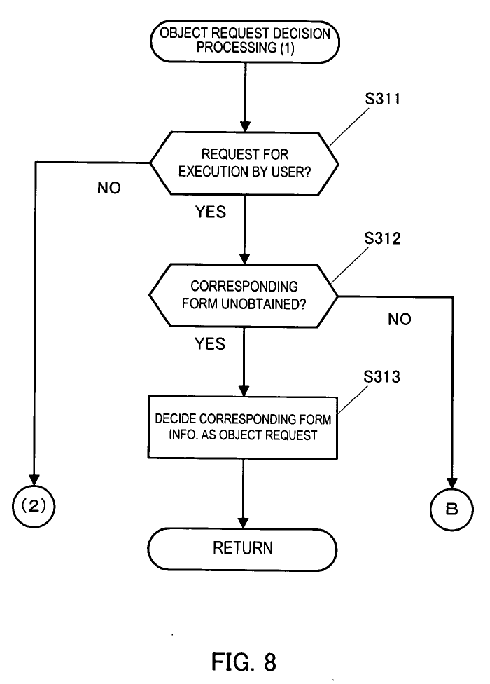

In the mobile terminal 200, object request decision processing for deciding a form that requests provision from the server 100 is executed as required. The object request decision processing is explained with reference to flowcharts illustrated in FIGS. 8 to 10.

During the object request decision processing, at least processing (1) to (3) illustrated in FIGS. 8 to 10 is executed. These processing may be executed sequentially or in parallel with each other. In the present embodiment, the explanation is given on the assumption that they are executed sequentially.

First of all, object request decision processing (1) illustrated in FIG. 8 is executed. Here, an object to be requested is decided based on an arbitrary request from the user. First, if the user operates the input section 260 of the mobile terminal 200 during the execution of the terminal program to request execution of an arbitrary form (step S311: Yes), the control section 210 searches the transfer information storing section 250 to determine whether the requested form is stored, thereby determining whether the relational form has been obtained or not (step S312).

Then, if the relational form has been already obtained from the server 100 and stored in the transfer information storing section 250 (step S312: No), the processing flow proceeds to the form execution processing (step S700) to execute the relational form.

On the other hand, if the relational form has not been obtained yet (step S312: Yes), the relevant requested form is decided as a request object to the server 100 (step S313), and the processing flow goes back to the form request processing illustrated in FIG. 7.

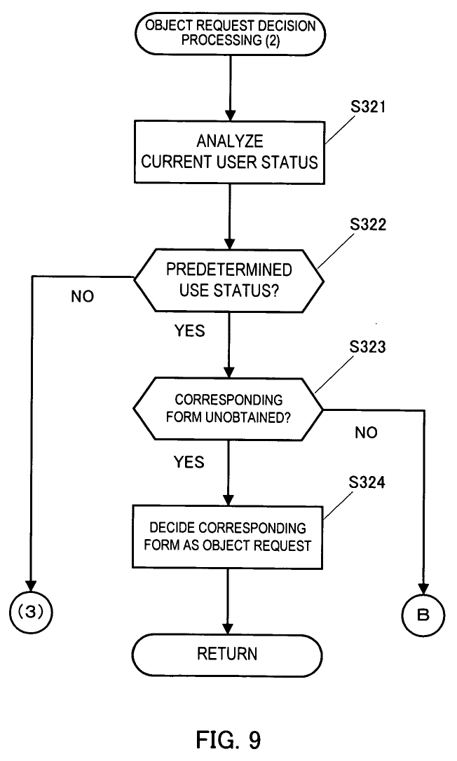

If there is no execution request from the user (step S311: No), object request decision processing (2) illustrated in FIG. 9 is executed.

During the object request decision processing (2), a request object is decided according to a user status. First, the control section 210 analyzes the user status detected in step S101 illustrated in FIG. 7 (step S321) and determines whether the current user status is a predetermined status (hereinafter referred to as “form request status”) where a form should be requested of the server 100 (step S322). Here, it is assumed that the form request status and the form that is requested at this time are preregistered to be associated with each other as data used by the terminal program. Namely, for example, association is performed so that a questionnaire page relating to a predetermined shopping is requested if the user status is “on shopping” and a shopping site relating to sports goods is requested if the user status is “in watching sports.” These associations may be set to the terminal program by default or arbitrarily registered by the user.

In the case of the form request status preregistered in this way (step S322: Yes), the control section 210 searches the transfer information storing section 250 to determine whether a form corresponding to the relational form request status has been already stored, thereby determining whether the relational form has been obtained or not (step S323). In this case, if the relational form has been already obtained (step S323: No), the processing flow proceeds to the form execution processing (step S700) to be described later to execute the relational form.

On the other hand, if the relational form has not been obtained yet (step S323: Yes), the control section 210 decides the relational form as a request targed (step S324).

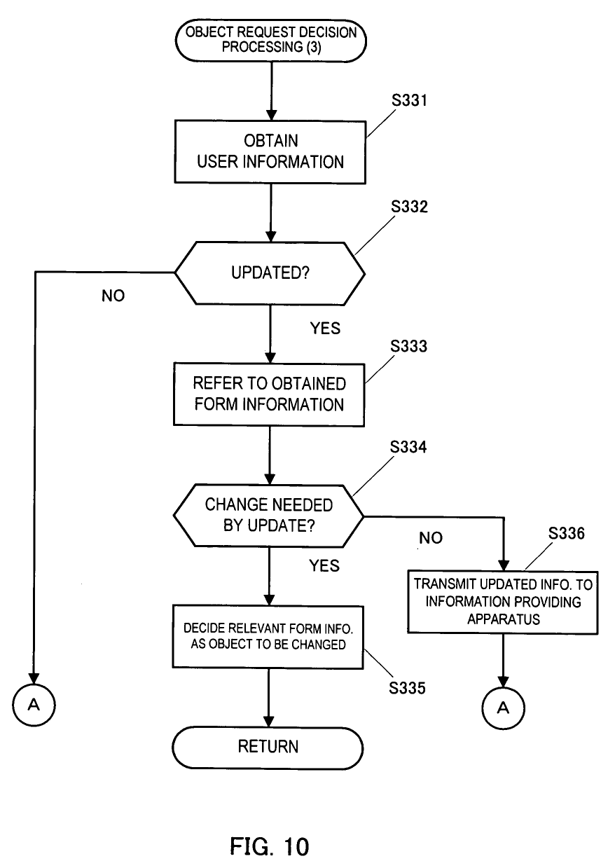

Or, if the user status is not the form request status (step S322: No), object request decision processing (3) illustrated in FIG. 10 is executed.

An explanation is given of object request decision processing (3) with reference to a flowchart illustrated in FIG. 10. Here, a request object is decided based on user information recorded on the user information storing section 230.

First, the control section 210 obtains recorded user information from the user information storing section 230 (step S331).

The control section 210 determines whether there is an update in the relevant user information based on the obtained user information (step S332). For example, it is determined whether an age has been updated based on the recorded date of birth. Or, it is determined whether user information has been updated by a user's arbitrary input. Accordingly, the object request decision processing (3) may be executed at the time of user's input for updating user information.

If user information is determined as being updated (step S332: Yes), the control section 210 determines whether a change in these obtained forms is needed due to the update of user information with reference to the form stored in the transfer information storing section 250 (step S334). For example, determination on “whether the relational form matches the current age by updating age information if a form using a predetermined age as an object is obtained” and “whether the relational form matches the user due to a change in taste if a form using a predetermined taste as an object is obtained” is executed.

Here, if it is determined that a change in the obtained form is needed due to the update of user information (step S334: Yes), the control section 210 decides the relational form as an object to be changed (step S335).

On the other hand, if it is determined that the change in the obtained form is not needed (step S334: No), one that serves as a notifying object to the server 100 among changed user information is transmitted to the server 100 (step S336). In the server 100, the user information database 130 is updated based on user information transmitted in step S336.

After the user information is transmitted in step S336, or if there is no update of user information (step S332: No), the processing flow goes back to step S101 illustrated in FIG. 7 to perform detection of the user status again.

The control section 210 generates request information that requests the form decided in steps S313, S324, or S335 (or requests a change), and transmits the result to the server 100 via the communications control section 220 (step S102).

In the server 100, if request information is received from the mobile terminal 200 (step S204: Yes), form provision processing (step S800 to be described later) is executed based on the received request information.

The above is processing when the mobile terminal 200 decides an object to be requested. While, there is a case in which the server 100 decides a form that is provided to the mobile terminal 200 in some cases. Processing in this case is explained with reference to a flowchart illustrated in FIG. 7.

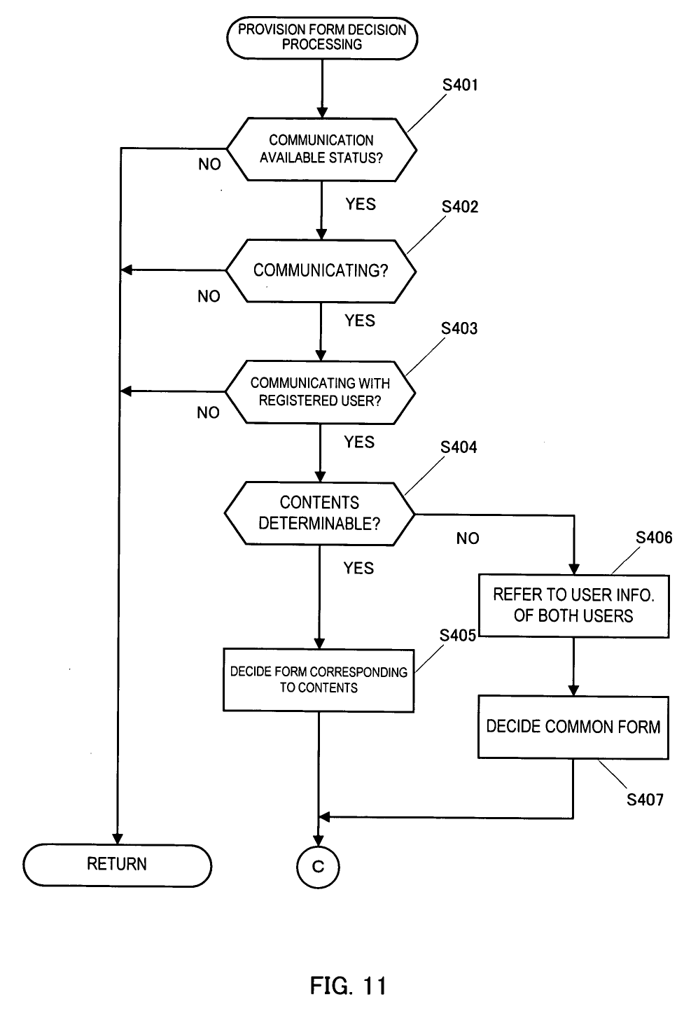

First, the control section 110 of the server 100 executes provision form decision processing (step S400) based on the user status information transmitted from the mobile terminal 200 in step S101 and recorded on the user information database 130 in step S201. The provision form decision processing is explained with reference to a flowchart illustrated in FIG. 11.

First, the control section 110 determines whether the corresponding user (mobile terminal 200) is in a communication available status based on user status information updated and registered in step S201 (step S401). Namely, for example, it is determined whether the user status is an unfavorable communication status such as “at working” in addition to a physical status on whether the mobile terminal 200 and the terminal program are started.

Here, if the corresponding user is in a communication available status (step S401: Yes), the control section 210 determines whether the relevant user is communicating with the other person (step S402). If the user is communicating (step S402: Yes), it is determined whether a communication partner is the other registered user that uses the present information provision service (step S403). Since cross reference of user status information is performed between the users, who use the same IM service, and user status information in which this is reflected is obtained, thereby making it possible to make determination.

Here, if the communication partner is a registered user (step S403: Yes), the control section 210 further determines whether the contents of the relevant communication are determinable (step S404). Here, for example, if the relevant users join in a chat or an electronic conference using IM, the theme is referenced as communication contents.

If the communication contents are determinable (step S404: Yes), the control section 210 decides a form that matches the relevant communication contents as an object to be provided (step S405).

On the other hand, if the communication contents are not determinable (step S404: No), the control section 210 gains access to the user information database 130 and refers to “attribute information” and “taste information” of both users (step S406) to decide a form corresponding to the attribute and the taste that are in common to both user as a provision object (step S407). If the provision object is decided in step S405 or S407, the processing flow proceeds to form provision processing to be described later (step S800), so that the decided form is provided to the mobile terminal 200.

On the other hand, in the case of the communication unavailable status (step S401: No), no communicating (step S402: No) or no communication with the registered user (step S403: No), the processing flow proceeds to step S202 illustrated in FIG. 7.

In step S202, the control section 110 detects a self-status of the server 100 (hereinafter referred to as “server status”). For example, detection on whether the relevant status is a status where the server 100 stops providing services (hereinafter referred to as “out of service status”) caused by error detection of the server 100 or scheduled maintenance, and detection on whether the form registered in the provision information database 140 is being updated or changed (hereinafter referred to as “form updating status”) are performed.

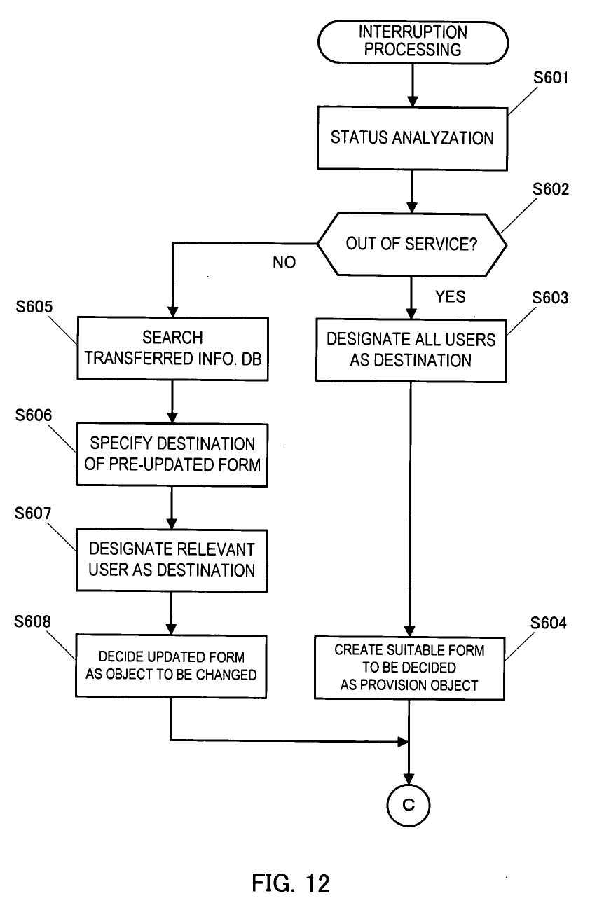

If the detected sever status is a predetermined status (namely, out of service status, form updating status, etc.) (step S203: Yes), the control section 110 executes interruption processing (step S600). The interruption processing is explained with reference to a flowchart illustrated in FIG. 12. In the present embodiment, the following explains a case in which the out of service status and the form updating status are a predetermined server status as an example.

First, the control section 110 analyzes the server status detected as a predetermined server status (step S601), and determines whether the status is out of service (step S602).

In a case where the status shows out of service (step S602: Yes), the control section 110 designates all users registered in the user information database 130 as a transfer destination (step S603), notifies the users of the out of service status, and creates a form (hereinafter referred to as “out of service notice form”) for restricting form execution by the mobile terminal 200 (step S604). Here, the control section 110 may create it automatically based on a predetermined form creation program or cause the output section 170 to display a message encouraging creation of an out of service notification form, and notify it to a person in charge of creating a form. The created out of service notification form is stored in the provision information database 140. Then, the control section 110 decides the created out of service notification form as a transfer object. Additionally, if there is a form that is prepared in a fixed format in advance, the creation may be omitted and the prepared form may be decided as a transfer object.

On the other hand, in the case where the predetermined server status is a form updating status (step S602: No), the control section 110 searches the transferred information database 150 (step S605) and specifies a transfer destination (namely, user ID) where a pre-updated form is transferred (step S606).

Then, the specified user ID is designated as a transfer destination of the updated form (step S607), and the relevant updated form is decided as an object form to be changed (step S608).

The control section 110 executes form provision processing (step S800) to be described later, and transfers the form (out of service notification form or updated form) decided in step S604 or S608, to the mobile terminal 200.

While, in the case of no server status that needs interruption processing (step S203: No), the control section 110 waits for request information from the mobile terminal 200 (step S204). Detection of the self-status of step S202 is repeatedly executed until request information is received from the mobile terminal 200.

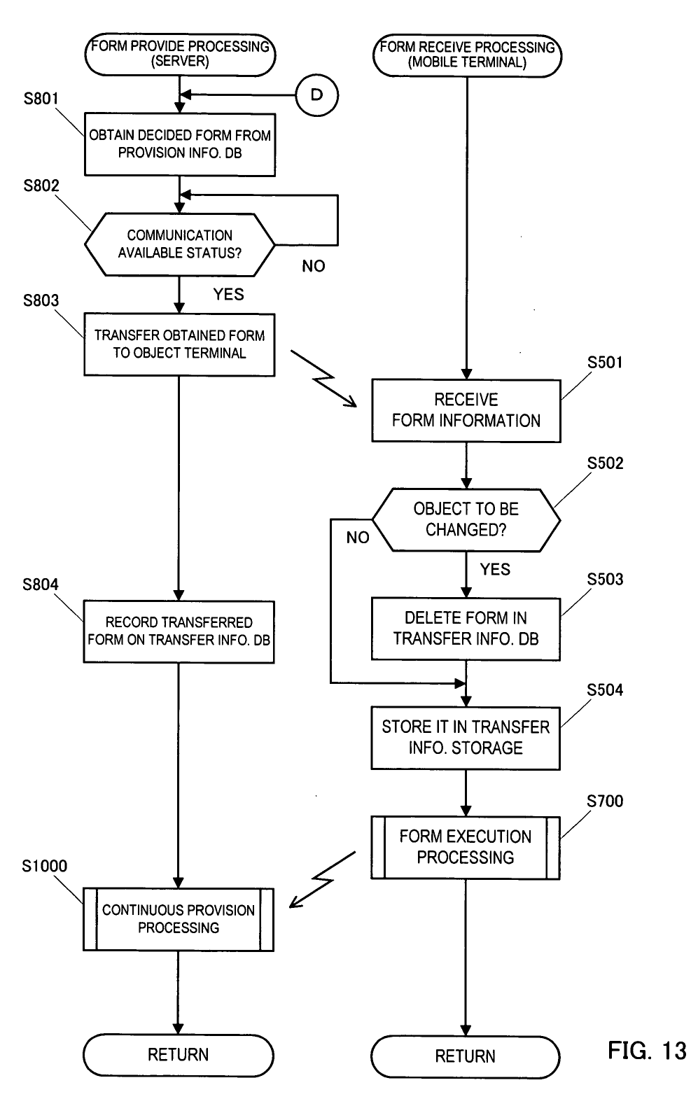

Next, the server 100 provides a form decided based on the request from the above mobile 200 or the user status or server status to the mobile terminal 200 (step S800 “form provision processing”), and processing in which the mobile terminal 200 receives the form (step S500 “form reception processing”) is executed. An explanation is given of form provision processing and form reception processing with reference to a flowchart illustrated in FIG. 13.

First, the control section 110 of the server 100 obtains a form shown by request information received in step S204 or a form decided in step S604 or S608 from the provision information database 140 (step S801).

Next, the control section 110 accesses the user information database 130 to determine whether a provision object is in a communication available status with reference to “status information” in connection with the corresponding user (mobile terminal 200) if the form is decided based on the request information, the user status, or the server status (excepting the out of service status) and all users if the form is decided based on the service status (step S802).

If the provision object is in a communication available status (step S802: Yes), the control section 110 transfers (transmits) the form obtained in step S801 to the mobile terminal 200 as the provision object via the communications control section 120 (step S803). Additionally, if it is requested as a change object in the above object request decision processing (3), or the updated form is transferred based on the “form updating status” in the interruption processing, additional information indicating a change object is transmitted together at the transferring time. Moreover, in the case where the updated form is transferred, if reply information is recorded on a “reply contents” field corresponding to the no-updated form of the transferred database 150, the contents are transferred together.

The control section 110 records information relating to the form transferred in step S802 on the transferred information database 150 (step S804). Namely, a user ID indicating a user as a transfer destination, a transfer time and date, and a form ID of the transferred form are recoded thereon. Additionally, at this point, “NULL” is set in a “reply contents” field.

In the mobile terminal 200, if the communications control section 220 receives a form from the server 100 (step S501), the control section 220 determines whether the received form is a change object (step S502).

In a case where it is the change object (step S502: Yes), the control section 210 accesses the transfer information storing section 250 to delete the corresponding form (step S503), and stores the received form (step S504). Also, if one that is changed based on the “form updating status” is transferred together with reply contents information, the information is stored therein.

Regarding the form which is not the change object, the transferred form is stored in the transfer information storing section 250 (step S502: No, S504).

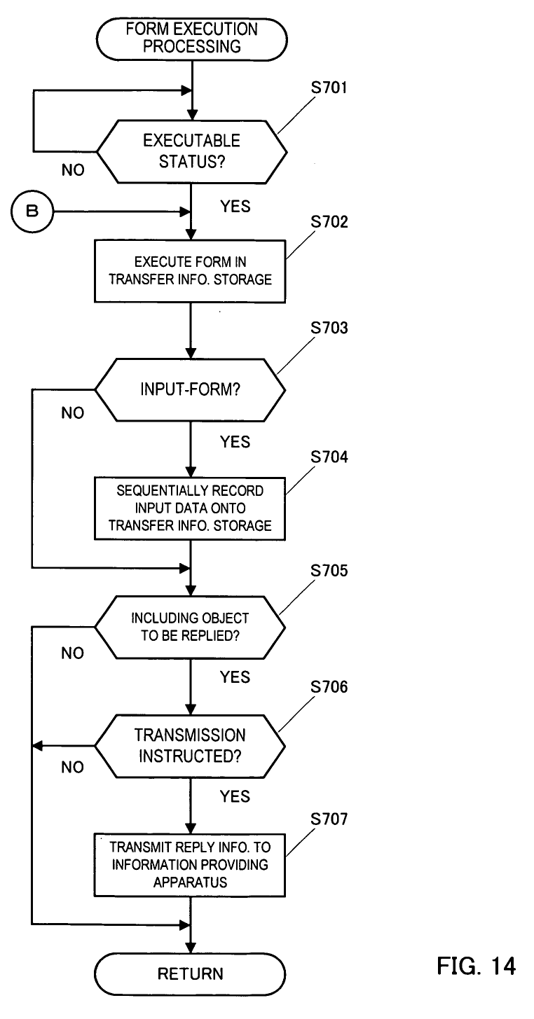

The control section 210 executes form execution processing for executing the form stored in the transfer information storing section 250 (step S700). The form execution processing is explained with reference to a flowchart illustrated in FIG. 14.

The control section 210 determines whether the form is executable based on the current user status detected in step S101 illustrated in FIG. 7 (step S701). For example, if the user status is in an unfavorable status for executing the form such as “at working” or the user can not recognize the form even if the mobile terminal 200 executes the form by, for example, a sleep status, it is determined that the form is unexecutable.

If the form is in the executable status (step S701: Yes), the control section 210 accesses the transfer information storing section 250, and executes the form stored at step S504 (step S702). Or, if execution of the form obtained in the request object specific processing (1) and (2) is designated, the relational form is executed. Additionally, if an object form to be executed is a “out of service notification form”, the relational form is executed, so that the point indicating that the form can not be executed during designated period (out of service period) is displayed on the output section 270. In addition to this, execution of the form during the designated time is restricted in cooperation with the terminal program.

On the other hand, if the form is in unexecutable status (step S701: No), the control section 210 waits for execution of the form until the form executable status is reached.

Here, if the executed form is one that requests the user to input a predetermined item (for example, a questionnaire, etc.) (step S703), the control section 210 records information input from the input section 260 on the transfer information storing section 250 sequentially to be associated with the relational form (step S704).

Next, the control section 220 determines whether some information must be replied to the server 100 by executing the relational form (step S705). Namely, in the case of the questionnaire page, an input reply must be replied to the server 100, and in the case of the EC site, information such as article designation, etc, must be replied.

If there is an object to be replied (step S705: Yes), the control section 210 waits for a transmission instruction from the user and sends reply object information to the server 100 (step S706: Yes, S707), and the processing flow goes back to form reception processing illustrated in FIG. 13.

If there is no reply object (step S705: No), or there is no instruction for transmission (step S706: No), the processing flow goes back to form reception processing without performing transmission to the server 100.

Additionally, input information stored in the transfer information storing section 250 in step S703 is retained in the transfer information storing section 250 until transmission of the input information to the server 100 is completed. In other words, if the entry of the input form is interrupted halfway through the entry or input information is not sent back to the server 100 by interruption of communication halfway through the transmission, the previously entered input signal is called from the transfer information storing section 250 at the time of re-executing the relational form, so that a reentry of the same information by the user is omitted.

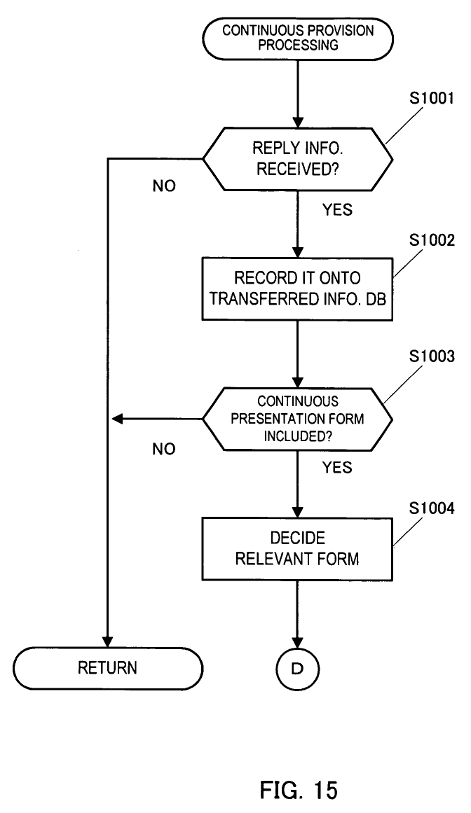

During the form execution processing through step S700, if information is transmitted to the server 100, continuous provision processing (step S1000) is executed by the server 100. The continuous provision processing is explained with reference to a flowchart illustrated in FIG. 15.

If the communications control section 120 of the server 100 receives reply information from the mobile terminal 200 (step S1001: Yes), the control section 110 accesses the transferred information database 150 to record the received reply information on a “reply contents” of the corresponding record (step S1002).

The control section 110 determines whether there is a form that should be continuously presented to the mobile terminal 200 in the relevant reply information (step S1003). For example, if a reply (reply information) of the first page of the questionnaire pages is received, the control section 110 determines whether there is a further page associated with the reply. Here, the presence or absence of a continuous presentation form is determined based on a “relational form” of the provision information database 140.

If there is a continuous presentation form (step S1003: Yes), the control section 110 decides the relational form as an object form to be provided (step S1004). The control section 110 executes form provision processing illustrated in FIG. 13 again to perform processing in steps S801 to S803, so that the form decided in step S1004 is provided to the mobile terminal 200.

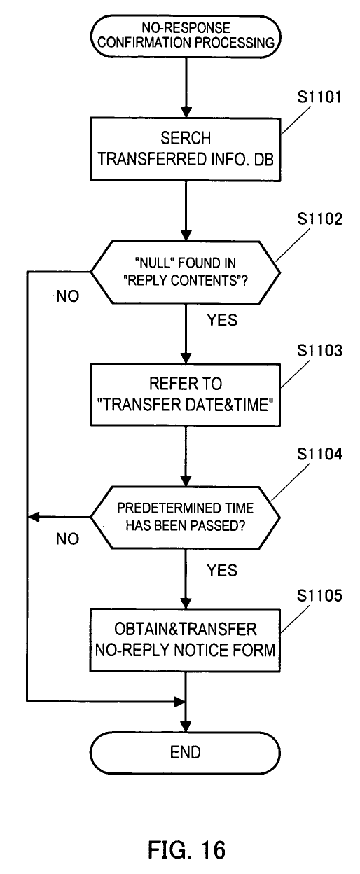

As mentioned above, if the entry of the input form is interrupted or the transmission of input information to the server 100 is not completed, the input information is retained by the mobile terminal 200 and the reentry is omitted at the time of re-executing the form. However, the presence or absence of reply relating to the reply information is detected by the server 100, so that a predetermined processing may be performed. No-response confirmation processing in this case (step S1100) is explained with reference to a flowchart illustrated in FIG. 16.

The control section 110 of the server 100 searches a record where “reply contents” are “NULL” in the transferred information database 150 for each predetermined time (step S1101). If there is the corresponding record (step S1102: Yes), information of a “transfer time and date” of the record is referenced (step S103).

The control section 110 compares the current time and date with the referenced transfer time and date to determine whether more than a predetermined time (for example, one week, etc) has been passed since transfer (step S1104). Here, if more than the predetermined time has been passed (step S1104), a no-reply notification form is transferred to the user of the relevant record (step S1105). The no-reply notification form is executed by the mobile terminal 200, so that the presence of no-reply information is notified to the user and retransmission processing is performed as required. In addition, the no-reply notification form is created in a fixed format in advance, and stored in the provision information database 140. Accordingly, the control section 110 obtains the relevant no-reply notification form from the provision information database 140 and transfers it to the mobile terminal 200 as an object to be transferred. Moreover, here, it is assumed that predetermined information (object form ID, etc) is added by the control section 110.

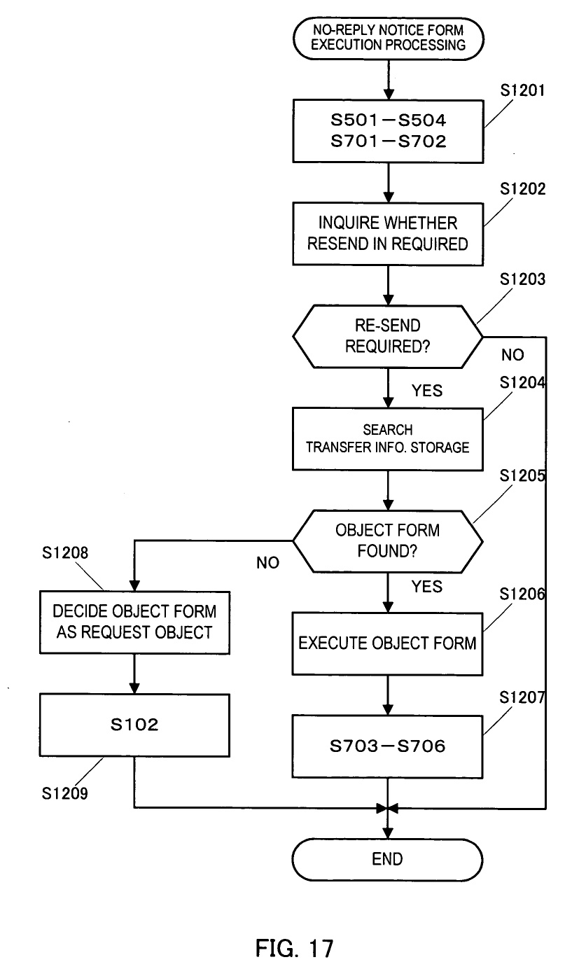

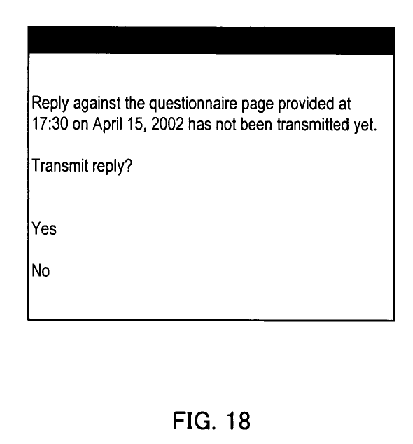

An explanation is given of processing (“no-reply notice form execution processing” (step S1200)) if the mobile terminal 200 executes the transferred no-reply notification form with reference to a flowchart illustrated in FIG. 17.

First, the control section 210 of the mobile terminal 200 controls the communications control section 220 to perform the same processing as those in steps S501 to S504 in the form reception processing of FIG. 13 and in steps S701 to S702 in the form execution processing in FIG. 14, so that reception, storage, and execution (a case of executable status) of the no-reply notification form transferred through the aforementioned no-reply notification form transfer processing are performed (step S1201).

If the mobile terminal 200 executes the no-reply notification form in cooperation with the terminal program, a message, which asks whether the reply being input should be transmitted to the information provision server 100, and a reply (“Yes” or “No”) to the inquiry are displayed on the output section 270 (step S1202).

The user operates the input section 260 and replies as to whether the transmission of the reply is needed. Here, if no reply is needed, namely, “No” is selected (step S1120), processing is ended. While, if the reply is needed, namely, “Yes” is selected (step S1203: Yes), the control section 110 searches the transfer information storing section 250 (step S1204) to determine whether there is the relational form (step S1205).

Here, if there is the relational form in the transfer information storing section 250 (step S1205: Yes), the control section 210 executes the relational form (step S1206). At this time, if input information is stored, the relational form is included in the relational form to execute the form, so that the reentry of input information by the user is omitted.

The control section 210 executes the same processing as those in steps S703 to 706 in the form execution processing shown in FIG. 14 to transmit input information and newly input information to the server 100 (step S1207) and end processing. In the server 100, continuous provision processing illustrated in FIG. 15 is executed as required.

On the other hand, for example, if the object form is deleted from the transfer information storing section 250 by cancellation and capacitance limitation of the transfer information storing section by an instruction from the user (step S1205: No), the control section 210 decides the relational form as an object to be requested (step S1208), generates request information that requests the decided form by the same processing as that of step S102 in FIG. 7, and transmits it to the server 100 (step S1209). The server 100 executes the aforementioned processing to transfer the form requested by request information to the corresponding mobile terminal 200.

As explained above, according to the mobile network system 1 relating to the embodiment of the present invention, since user status information based on IM is used in addition to the case where the user requests, making it possible for the server 100 and/or the mobile terminal 200 to automatically decide suitable information (form) to be provided to the user and actively provide it to the user with a suitable timing, effective information provision can be implemented and no user's operation is needed and high convenience is obtained.

Moreover, suitable information can be provided according to a change in user attribute and taste. In this case, since update of user information is automatically executed based on one that is made by the mobile terminal 200, the user does not have to input the same contents many times, so that user's convenience can be improved.

Furthermore, if the executed form needs the user's input to the questionnaire page, input information is retained in the mobile terminal 200 as required. Accordingly, even if the entry of the input form is interrupted halfway or transmission to the server 100 is incompleted, previously input information is reproduced at the time of executing the same form next time, so that the same information does not have to be input again. Moreover, if no-reply information is checked in the server 100 and is not replied for more than a predetermined time, this fact is notified and the same form is executed without user's operation, so that the restart of the interrupted reply can be promoted. For this reason, the information provider can effectively collect information and improve user's convenience.

Furthermore, if the service is stopped by trouble on the server 100 or the like, the point is notified to each mobile terminal 200, so that the user can easily specify the causes of the interruption of communication or service stop, thus improved usability is available.

In the above embodiment, input information input by executing the form by the mobile terminal 200 is retained by the mobile terminal 200 as required, and the input information is reproduced at the re-executing time. However, the input information may be retained by the mobile terminal 200 and transmitted to the server 100 concurrently, and recorded on the transferred information database 150. According to the above configuration, in the above no-reply notice form execution processing, even if there is no object form in the mobile terminal 200, previously input information can be reproduced. In this case, at the time of transmitting input information to the server 100, additional information, which indicates, for example, “all items are not input” or “ordinary information transmission is not performed”, is recorded to be associated with the transferred information database 150. Accordingly, in the no-reply conformation processing, additional information is detected to make it possible to determine whether there is no-reply.

Additionally, the above embodiment explains the example of the form that configures the questionnaire page or the EC site. However, any kind of information may be provided. For example, a form that configures a game and an auction site, and a form that provides stock information and news may be used as a form. In either case, necessary and appropriate information can be actively provided according to the user status, thereby contributing to information provider efficiency and user convenience.

### Second Embodiment

Though the first embodiment shows the case in which the server 100 performs information provision to the mobile terminal 200 using IM, the server 100 can also perform job management of the mobile terminal 200. Namely, the server 100 controls each mobile terminal 200 to operate each mobile terminal 200 according to a job priority set by each user. Additionally, the jobs performed by the mobile terminal 200 are to execute transmission and reception of phone calls, transmission and reception of e-mail, and application programs. If an execution request of job B, which has a higher priority than job A, occurs while the mobile terminal 200 executes job A, the server 100 controls the mobile terminal 200 to rest (interrupt) job A halfway to execute job B. The following explains an embodiment of this case.

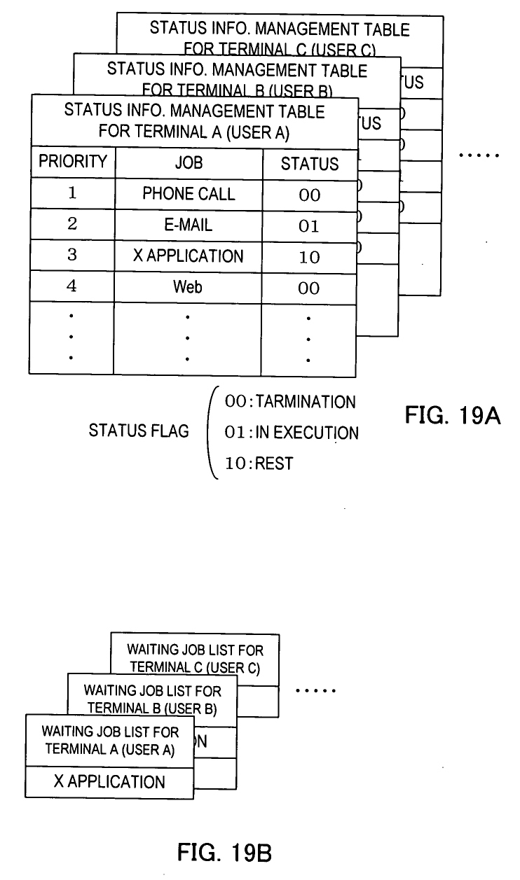

Though a hardware configuration of the present embodiment is the same as that of the first embodiment, the user information DB 130 of the server 100 stores a status information management table, which indicates a terminal using status of each user shown in FIG. 19A, and a waiting job list shown in FIG. 19B.

The status information management table is created for each mobile terminal 200 (user) as illustrated in FIG. 19A and indicates the terminal using status of each user, namely, an operating status of the mobile terminal 200. The operating status of the mobile terminal 200 is shown by a status flag.

Regarding the status flag, as illustrated in FIG. 19A, for example, “00” indicates that the job is terminated, “01” indicates that the job is being executed, and “10” indicates that the job is rested (interrupted) halfway. Moreover, the status information management table indicates the priority of jobs executed by the mobile 200. Additionally, the priority of jobs can be set by the user with operating the mobile terminal 200 to access the server 100.

The waiting job list is created for each mobile terminal 200 (user) as illustrated in FIG. 19B. As described above, each job is executed according to the priority set by the user. For this reason, a low priority job will be executed after a high priority job ends. The waiting job list indicates waiting jobs waiting for end of such the high priority job.

An explanation is next given of an operation of the mobile network system 1 according to the present embodiment.

The user of each mobile terminal 200 operates the input section 260 of the mobile terminal 200, which the user possesses, to access the server 100, and sets the priority of jobs to be executed on the user's own mobile terminal 200.

In response to the user's access, the control section 110 stores information of jobs to be executed by the mobile terminal 200 onto the status information management table in the user information DB 130, according to the priority set by the user. This makes it possible to set the priority of jobs to be executed by the mobile terminal 200.

The server 100 manages the operation status of each mobile terminal 200 using the status information management table created by the above-explained operation.

When causing the mobile terminal 200 to execute a desired job, the user operates the input section 260 of the mobile terminal 200 to designate the desired job. In response to the user's operation, the input section 260 outputs a user execution signal which instructs the execution of the job designated by the user, to the control section 210.

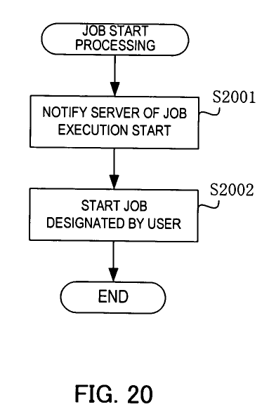

In response to the user execution signal supplied from the input section 260, the control section 210 starts job start processing shown in FIG. 20 according to a program stored in the program storing section 240.

First, the control section 210 notifies the server 100 of execution of the job designated by the user starts (step S2001).

More specifically, the control section 210 transmits start data including data indicating the user's own mobile terminal 200, a start job as an object to be executed, and start of the job, to the server 100 via the communications control section 220. Additionally, data (information), which is transmitted and received between the server 100 and the mobile terminal 200, is transmitted and received after being disassembled into packets.

After that, the control section 210 starts execution of the job designated by the user, according to the program stored in the program storing section 240 (step S2002), and terminates job start processing.

While, in response to the start data supplied from the mobile terminal 200, the control section 110 of the server 100 updates the status information management table of the mobile terminal 200 which has transmitted the start data, stored in the user information DB 130.

More specifically, the control section 110 specifies the mobile terminal 200 which has transmitted the start data, with using data indicating the mobile terminal 200 included in the supplied start data.

Sequentially, the control section 110 specifies a start job with using data indicating the start job included in the supplied start data.

Then, the control section 110 controls user information DB 130 and rewrites status “00” (terminated) of the specified start job stored in the status information management table of the specified mobile terminal 200 to “01” (in execution).

In this way, the start of job execution by the mobile terminal 200 in response to the user's operation, is notified to the server 100.

Moreover, if a job execution request (e-mail, or request for phone call connection) from the other terminal via the communication network 10 (Internet and the like) is supplied, the control section 100 of the server 100 controls the operation of the mobile terminal 200 which is an object that executes a requested job, as described below.

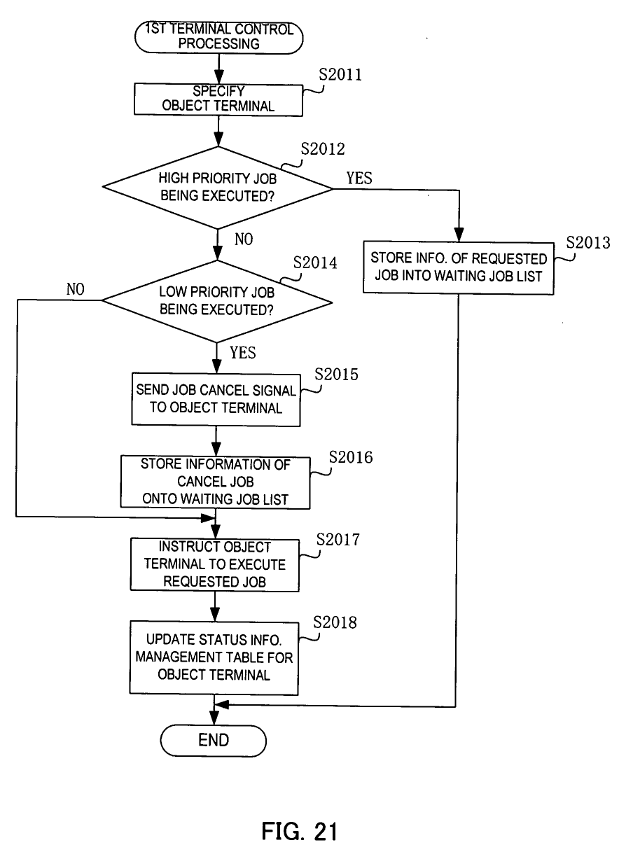

In response to the supplied job execution request, the control section 110 starts a first terminal control processing illustrated in FIG. 21 according to a program in the program storing section 180.

First, the control section 110 specifies a mobile terminal 200 as an object to be controlled (object terminal) from the supplied job execution request (step S2011).

For example, if the execution request indicates e-mail, the control section 110 specifies the object terminal with using an address indicating an e-mail destination. Furthermore, if the execution request indicates the request for phone call connection, the control section 110 specifies an object terminal by a telephone number.

Next, the control section 110 searches the status information management table of the specified object terminal stored in the user information DB 130, and determines whether a job, which has a higher priority than the request job requested to be executed, is being executed (step S2012). This makes it possible for the control section 100 to determine whether the object terminal can execute the request job.

If it is determined that the high priority job is being executed, namely, the object terminal can not execute the request job (step S2012: Yes), the control section 110 stores information indicating a request job in the waiting job list for the object terminal stored in the user information DB 130 (step S2013), and terminates the terminal control processing. Additionally, if information indicating multiple jobs is stored in the waiting job list, the control section 110 sorts the information of the respective jobs according to the priority set by the user, and stores them.

On the other hand, if it is determined that the high priority job is not being executed, namely, the object terminal can execute the request job (step S2012: No), the control section 110 searches the status information management table of the object terminal, and determines whether a job whose priority is lower than the request job, is being executed (step S2014).

If it is determined that the low priority job is not being executed (step S2014: No), the control section 110 performs processing of step S2017 to be described later.

On the other hand, if it is determined that the low priority job is being executed (step S2014: Yes), the control section 110 transmits a job interruption signal, which instructs interruption (rest halfway) of the job being executed, to the object terminal via the communications control section 120 (step S2015).

In response to the job interruption signal supplied from the server 100, the control section 210 of the object terminal stores a present state of the job being executed, in the program storing section 240, and interrupts the job being executed. Then, the control section 210 transmits an interruption completion signal, which indicates that the job is interrupted, to the server 100 via the communications control section 220.

In response to the interruption completion signal sent from the object terminal, the control section 110 of the server 100 stores information indicating the interrupted interruption job in the waiting job list of the object terminal stored in the user information DB 130 (step S2016). Additionally, similar to the above, if information, which indicates multiple jobs, is stored in the waiting job list, the control section 110 stores information of each job according to the priority.

Then, the control section 110 transmits a server execution signal, which instructs execution of the request job, to the object terminal via the communications control section 120 (step S2017).

After that, the control section 110 updates the status information management table for the object terminal stored in the user information DB 130 (step S2018). More specifically, the control section 110 rewrites the status of the interrupted interruption job from “01” (in execution) to “10” (resting), and rewrites the status of the started request job from “00” (terminated) to “01” (in execution). Additionally, if the job with a low priority is not determined as being executed in the above step S2014, the control section 110 rewrites only the status of the request job.

In response to the server execution signal transmitted in the above step S2017, the control section 210 of the object terminal executes the requested job instructed by the server execution signal according to a program in the program storing section 240.

Additionally, at the time of interrupting the job being executed, or starting execution of the requested job according to control of the server 100, the control section 210 of the object terminal controls the output section 270 to display a predetermined message and graphics, output a voice, or blink a screen, so that the interruption and start of the job may be notified to the user.

As mentioned above, the job of the mobile terminal 200 can be executed according to the priority set by the user.

Furthermore, at the time of terminating the job which has been executed, the user operates the input section 260 of the mobile terminal 200 to designate a job to be terminated. In response to the user's operation, the input section 260 outputs a job termination signal, which instructs a termination of the job designated by the user, to the control section 210.

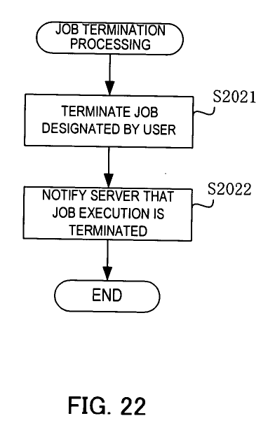

In response to the job termination signal supplied from the input section 260, the control section 210 starts job termination processing illustrated in FIG. 22 according to a program stored in the program storing section 240.

First, the control section terminates the job designated by the user (step S2021).

Then, the control section 210 notifies the server 100 of the job execution is terminated by the user's designation (step S2022). More specifically, the control section 210 transmits end data, which includes data indicating the user's own mobile terminal 200, a terminated job as an object to be terminated, and a job termination, to the server 100 via the communications control section 220.

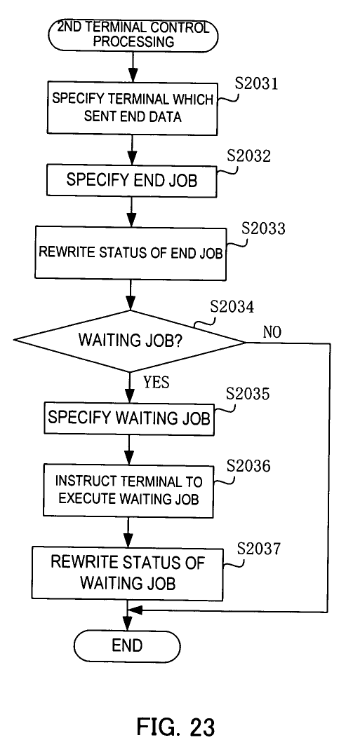

In response to the above end data supplied from the mobile terminal 200, the control section 110 of the server 100 starts second terminal control processing illustrated in FIG. 23 according to a program in the program storing section 180.

First, the control section 110 specifies a mobile terminal 200, which transmits the end data, with using data indicating the mobile terminal 200 included in the supplied end data (step S2031).

Sequentially, the control section 110 specifies the job termination with using data indicating the job termination included in the supplied end data (step S2032).

Then, the control section 110 controls the user information DB 130 and rewrites the status of the specified job termination, which is stored in the status information management table for the specified mobile terminal 200, from “01” (in execution) to “00” (terminated) (step S2033).

After that, the control section 110 determines whether information of the waiting job is stored in the waiting job list of the specified mobile terminal 200 stored in the user information DB 130 (step S2034). Accordingly, the control section 110 determines whether there is a waiting job.

If information of the waiting job is not determined as being stored, namely, there is no waiting job (step S2034: No), the control section 110 terminates the second terminal control processing.

On the other hand, if information of the waiting job is determined as being stored, namely, there is the waiting job (step S2034: Yes), the control section 110 specifies the waiting job with using information of the waiting job stored in the waiting job list (step S2035).

Additionally, if the waiting job list shows a plurality of waiting jobs, the control section 110 uses information of the highest priority job. As mentioned above, since the stored information in the waiting job list is ordered by the priority set by the user, the control section 110 specifies the waiting job with using information listed at the top or the bottom of the waiting job list.

Then, the control section 110 transmits a server execution signal, which instructs execution of the specified waiting job, to the specified mobile terminal 200 via the communications control section 120 (step S2036).

After that, the control section 110 rewrites the status of the waiting job to be executed, which is stored in the status information management table for the specified mobile terminal 200 in the user information DB 130, from “00” (terminated) or “10” (resting) to “01” (in execution) (step S2037), and termintates second terminal control processing.

In response to the server execution signal transmitted in the above step S2036, the control section 210 of the mobile terminal 200 starts (restarts) execution of the job instructed by the server execution signal according to the program in the program storing section 240.

As mentioned above, the job termination, which is executed by the mobile terminal 200 in response to the user's operation, is notified to the server 100. Moreover, if one job is terminated and there is a waiting job showing a low priority, the waiting job is automatically started (or restarted).

Furthermore, since the interruption and start (restart) of the job is executed by control of the server 100, the user does not have to operate the mobile terminal 200 to perform the interruption and start (restart) of the job. This facilitates the user's operation.

Moreover, since the interruption and start (restart) of the job is executed in accordance with the priority preset by the user, the mobile terminal 200 can surely execute the job which is the most important to the user. Accordingly, no confusion occurs in the user operation and the user can continue the operation efficiently.

Additionally, if the communication system shown in the above embodiment is applied to an instant message (IM) system, the distribution ranking (order) is assigned to the distribution destinations of the message, so that the message may be distributed according to the distribution order.

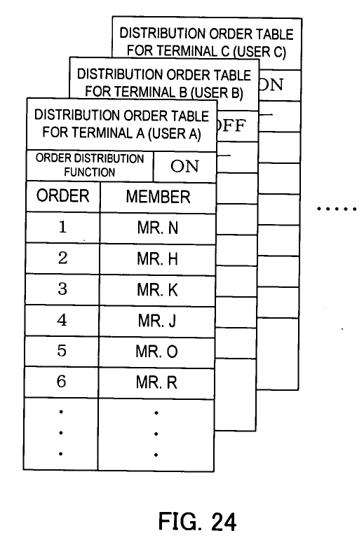

In this case, the user information DB 130 of the server 100 stores a distribution order table shown in FIG. 24 in addition to the above status information management table and the waiting job list.

The distribution order table is created for each mobile terminal 200 (user) and indicates the distribution ranking of the message distribution destinations as illustrated in FIG. 24. More specifically, information (for example, a telephone number of the mobile terminal 200 owned by the member) of each member belonging to the same group is stored according to the distribution order. Moreover, the distribution order table shows whether order distribution function, which distributes the message according to the order shown by the distribution order table, should be used.

Additionally, the message distribution order can be set in the same way as the case in which the user operates the mobile terminal 200 to access the server 100 to set the job priority. Furthermore, as to whether the order distribution function should be used, the user operates the mobile terminal 200 to access the server 100 to set it.

The following explains an operation of the system when a certain user transmits a message to another user (member) belonging to the same group.

When the user operates the input section 260 of the user's own mobile terminal 200 to designate an IM program as a job that is executed by the mobile terminal 200, the input section 260 outputs a user execution signal, which instructs execution of the job (IM program) designated by the user, to the control section 210, similar to the above.

In response to the user execution signal supplied from the input section 260, the control section 210 performs the above-mentioned job start processing to execute the IM program designated by the user.

If the user operates the input section 260 to input the message, the control section 210 transmits the message input by the user to the server 100 together with data indicating a sender and a destination

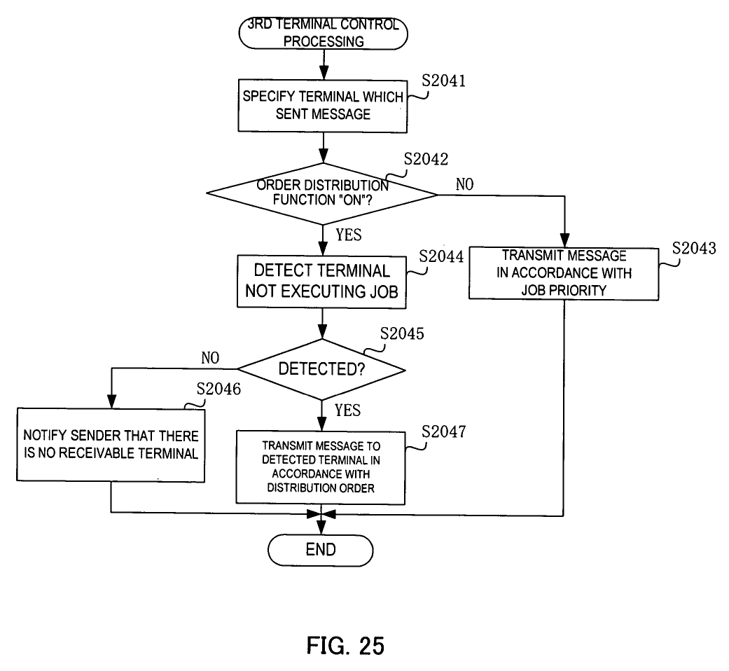

In response to the message supplied from the mobile terminal 200, the control section 110 of the server 100 starts third terminal control processing illustrated in FIG. 25 according to a program stored in the program storing section 180.

First, the control section 110 specifies the mobile terminal 200 which transmitted the message, with using data indicating the sender supplied together with the message (step S2041).

Then, the control section 110 determines whether the order distribution function should be used, with reference to the distribution order table of the specified mobile terminal 200 stored in the user information DB 130 (step S2042).

If it is determined that order distribution function is OFF (step S2042: No), the control section 110 transmits a message to each mobile terminal 200 as a destination of message distribution, according to the job priority (step S2043).

More specifically, the control section 110 executes the same processing as the aforementioned first terminal control processing to each mobile terminal 200 as the message distribution destination. Accordingly, if the job is not being executed, the control section 110 directly transmits the message to each mobile terminal 200 as destination of the message distribution. If the job whose priority is higher than the IM program being executed, the control section 110 transmits the message thereto after the high priority job is ended. Or, if the job whose priority is lower than the IM program being executed, the control section 110 transmits the message thereto after the low priority job is interrupted.

On the other hand, if it is determined that the order distribution function is ON (step S2042: Yes), the control section 110 detects a mobile terminal 200 not being executing the job, from the mobile terminals 200 as the distribution destinations, with reference to the distribution order table and the status information management table of the mobile terminal 200 detected at the step S2041 (step S2044).

Sequentially, the control section 110 determines whether the mobile terminal 200, which is not being executing the job, is detected (step S2045).

If it is detected that there is no mobile terminal 200 not being executing the job is detected (step S2045: No), the control section 110 transmits a transmission disable signal indicating the absence of the mobile terminal 200 being in a message receivable state, to the mobile terminal 200 which is a message sender (step S2046), and terminates the third terminal control processing.

On the other hand, if it is determined that there is the mobile terminal 200 not being executing the job (step S2045: Yes), the control section 110 transmits the message to the mobile terminal 200 not being executing the job detected in step S2044, according to the distribution order set by the user of the sender (step S2047), and terminates the third terminal control processing.

In this way, the message can be distributed according to the distribution order preset by the user.

### Third Embodiment

According to the aforementioned mobile terminal 200, in the case of using a presence notification that notifies a communication partner of the user status by IM, the mobile terminal 200 transmits information on whether the user uses a mobile terminal or whether there is a key input operation to the server with a predetermined timing while logging in the instant message system, and this causes a problem in which communication cost is required every time when the mobile terminal 200 transmits information. Moreover, if the user puts the mobile terminal 200 in a pocket or a bag, there sometimes occurs a state where information can not be transmitted from the mobile terminal 200, namely, a communication disable state. For this reason, when the user puts the mobile terminal 200 in the pocket or the bag while logging in the instant message system, the user status to be notified to the communication partner is not correctly updated in some cases. As a result, there is a case in which the communication partner waits uselessly for the user message.

The following explains an embodiment of the mobile network system 1 for avoiding such a problem.

Though the hardware configuration of the present embodiment is basically the same as that of the aforementioned embodiments, it is assumed that a folding type mobile terminal 200 is adopted. Accordingly, it is assumed that a folding state detector 280, which detects folding state of the mobile terminal 200, is provided in the mobile terminal 200 of the present embodiment in addition to the configuration illustrated in FIG. 6. The folding state detector 280 includes a switch for detecting folding state of the mobile terminal 200, and detects whether the mobile terminal 200 is unfolded or folded. If detecting that the mobile terminal 200 is unfolded, the folding state detector 280 outputs an unfold signal, which indicates that the mobile terminal 200 is unfolded, to the control section 210. Also, if detecting that the mobile terminal 200 is folded, the folding state detector 280 outputs a fold signal, which indicates that the mobile terminal 200 is folded, to the control section 210.

Moreover, it is assumed that the program storing section 240 stores a status transmission program for automatically transmitting a signal, which indicates folding state of the mobile terminal 200, to the server 100.

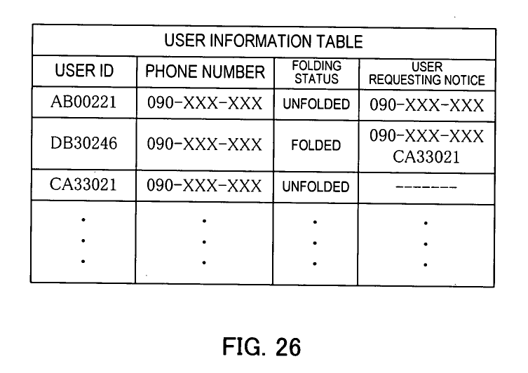

Furthermore, the user information DB 130 of the server 100 stores a user information table as illustrated in FIG. 26. The user information table stores a user ID, which the server 100 issues to the user, who performed a predetermined registration procedure, a telephone number of the mobile terminal 200, which the user possesses, folding state of the mobile terminal 200 and a notice requesting user to be associated with one another as illustrated in FIG. 26.

The “notice requesting user” is information (user ID, telephone number, or the like) for identifying the other user designated by the user. The server 100 notifies the user, who designates the notice requesting user, of the folding status of the mobile terminal 200 possessed by the user, who is designated as the notice requesting user, as described later. For example, if a user A designates a user B as a notice requesting user in advance, the folding state of the mobile terminal 200 possessed by the user B is notified to the user A. Additionally, multiple users may be designated as the notice requesting user.

An explanation is next given of an operation of the mobile network system according to the present embodiment.

A user, who uses a message service provided by the server 100, operates the input section 260 of the mobile terminal 200 to access the server 100, and performs a predetermined registration procedure in advance.

Through the registration procedure, the control section 110 of the server 100 issues a user ID to the user and stores information relating to the user, who performed the registration procedure, in a user information table stored in the user information DB 130. Then, the control section 110 supplies the issued user ID and a status transmission program for automatically transmitting the folding state of the mobile terminal 200 to the server 100 to the mobile terminal 200 of the user, who performed the registration procedure.

The control section 210 of the mobile terminal 200 possessed by the user, who performed the registration procedure, stores the user ID supplied from the server 100 and the status transmission program in the program storing section 240.

Moreover, the user, who is registered in the server 100, operates the input section 260 of the mobile terminal 200, so that the other user, who desires to know the folding state, can be designated as the notice requesting user. The control section 110 of the server 100 stores information (user ID, telephone number, or the like) indicating the other user designated by the user in the notice requesting user of the user information table stored in the user information DB 130.

The user, who performed the registration procedure, unfolds the mobile terminal 200 possessed by the user, so that the use of the message service provided by the server 100 can be started. Moreover, the user folds the mobile terminal 200 possessed by the user, so that a status change in the instant message service and the stop (interruption) to use the message service can be performed.

When the user unfolds the mobile terminal 200, the folding detecting section 280 of the mobile terminal 200 detects that the mobile terminal 200 is unfolded and outputs an unfold signal, which indicates that the mobile terminal 200 is unfolded, to the control section 210.

In response to the unfold signal supplied from the folding detecting section 280, the control section 210 transmits the user ID stored in the user information storing section 230 and the unfold signal to the server 100 according to a status transmission program of the program storing section 240.

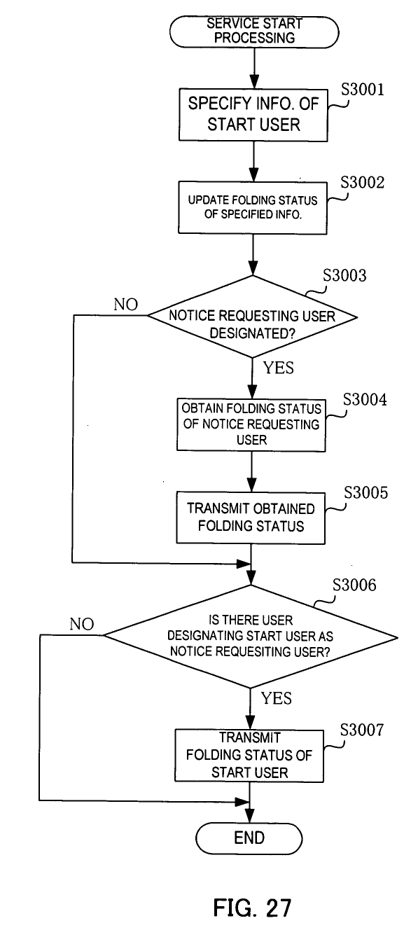

In response to the fold signal supplied from the mobile terminal 200, the control section 110 of the server 100 starts service start processing illustrated in FIG. 27 according to a program stored in the program storing section 240.

First, the control section 110 specifies information of a user (start user), who starts the use of the message server, from the user information table stored in the user information DB 130 using the user ID supplied together with the unfold signal (step S3001).

Then, the control section 110 updates the folding status included in information of the specified start user (step S3002). More specifically, the control section 110 rewrites the folding status of the start user from “fold” to “unfold.”

Sequentially, the control section 110 determines whether the start user designates the notice requesting user with reference to the user information table of the user information DB 130 (step S3003).

If it is determined that a notice requesting user is not designated (step S3003: No), the control section 110 performs processing in step S3006 to be described later.

On the other hand, if it is determined that a notice requesting user is designated (step S3003: Yes), the control section 110 searches the user information table of the user information DB 130 to obtain folding status of the notice requesting user designated by the start user (step S3004).

Then, the control section 110 transmits information indicating the obtained folding status of the notice requesting user to the mobile terminal 200 of the start user via the communications control section 120 (step S3005).

In response to information indicating the obtained folding status of the notice requesting user supplied from the server 100, the control section 210 of the mobile terminal 200 possessed by the start user controls the output section 270 to present the folding status of the notice requesting user indicated by the supplied information to the start user using characters, graphics, or voice, etc. This makes it possible for the start user to know the folding status of the desirable other user.

On the other hand, the control section 110 of the server 100 determines whether there is a user, who designates the start user as the notice requesting user, among the users who are using the message service, with reference to the user information table of the user information DB 130 (step S3006).

If it is determined that there is no user who designates the start user as a notice requesting user (step S3006: No), the control section 110 terminates service start processing.

On the other hand, if it is determined that there is a user who designates the start user as a notice requesting user (step S3006: Yes), the control section 110 transmits information indicating the folding status of the start user to the mobile terminal 200 of the user who designates the start user as the notice requesting user, (step S3007), and terminates the service start processing.

In response to information indicating the folding status of the start user supplied from the server 100, the control section 210 of the mobile terminal 200 possessed by the user who designates the start user as the notice requesting user, controls the output section 270 to present the folding status of the start user indicated by the supplied information to the user by characters, graphics, or voice, etc. This makes it possible for the user who designates the start user as the notice requesting user, to know that the mobile terminal 200 of the start user is unfolded, namely, the start user is watching the mobile terminal 200.

Next, when the user folds the mobile terminal 200, the folding detecting section 280 of the mobile terminal 200 detects that the mobile terminal 200 is folded, and outputs a fold signal indicating that the mobile terminal 200 is folded, to the control section 210.

In response to the fold signal supplied from the folding state detector 280, the control section 210 transmits the fold signal to the server 100 together with the user ID stored in the user information storing section 230 according to a status transmission program of the program storing section 240.

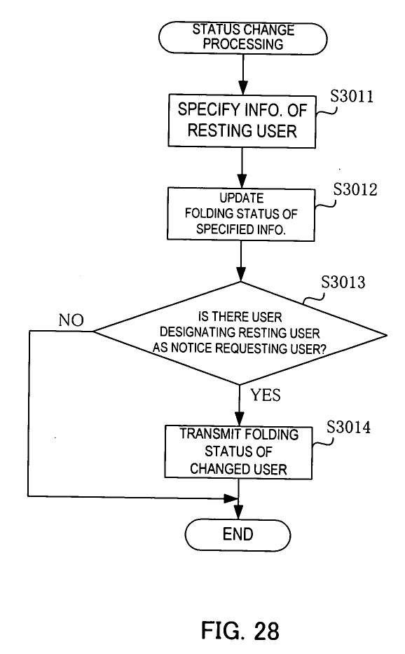

In response to the fold signal supplied from the mobile terminal 200, the control section 110 of the server 100 starts status change processing illustrated in FIG. 28 according to a program of the program storing section 180.

First, the control section 110 specifies information of a user, who folds the mobile terminal 200 (namely, a user who is not using the mobile terminal 200 presently: hereinafter referred to as “resting user”), from the user information table stored in the user information DB 130 using the user ID supplied together with the fold signal (step 3011).

Then, the control section 110 updates folding status included in information of the specified resting user (step S3012). More specifically, the control section 110 rewrites the folding status of the resting user from “unfold” to “fold.”

Sequentially, the control section 110 determines whether there is a user who designates the resting user as the notice requesting user among the users who are using the message service, with reference to the user information table of the user information DB 130 (step S3013).

If it is determined that there is no user who designates a resting user as the notice requesting user (step S3013: No), the control section 110 terminates the status change processing.

On the other hand, if it is determined that there is a user who designates a resting user as the notice requesting user (step S3013: Yes), the control section 110 transmits information indicating the folding status of the resting user to the mobile terminal 200 of the user who designates the resting user as the notice requesting user (step S3014), and terminates the status change processing.

In response to information indicating the folding status of the resting user supplied from the server 100, the control section 210 of the mobile terminal 200 possessed by the user, who designates the resting user as the notice requesting user, controls the output section 270 to present the folding status of the resting user indicated by the supplied information to the user by characters, graphics, or voice. This makes it possible for the user who designates the resting user as the notice requesting user, to know that the mobile terminal 200 of the resting user is folded, namely, the designated user is not watching the mobile terminal 200.

As mentioned above, each user may unfold the user's own mobile terminal 200 to know whether the pre-designated notice requesting user is watching the mobile terminal 200, namely, whether the message service is being available.

Moreover, the user unfolds or folds the mobile terminal 200, so that the other user who designates this user as the notice requesting user, can surely know whether the user is watching the mobile terminal 200, namely, whether the message service is being available. As a result, it is possible to prevent a case where the communication partner from waiting uselessly for the user response.

Additionally, at the time when the aforementioned fold signal is received, the service provided to the user by the server 100 may be stopped or interrupted.

Also, the status of the user (or mobile terminal 200) is set to “unfold” or “fold”, so that the mobile terminal 200 does not have to transmit information of whether there is a key input operation to the server 100, unlike the conventional case. For this reason, communication cost excepting message transmission and reception can be suppressed.

Moreover, the mobile terminal 200 transmits the unfold signal, so that information relating to radio field intensity and the like can be obtained.

For example, when a meeting member is designated as a notice requesting user, the meeting can be started at the time all members gather.

### Fourth Embodiment

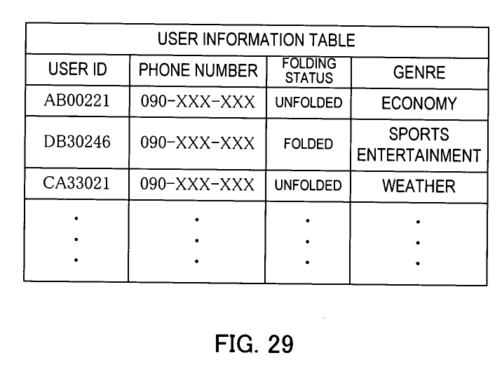

The following shows an application example if the folding status of the aforementioned mobile terminal 200 is detected. Though the hardware configuration of the present embodiment is the same as that of the third embodiment, the user information 130 of the server 100 stores information relating to the user, who can use information provision service registered in the server 100, namely, provided by the server 100. More specifically, the user information DB 130 stores a user information table as illustrated in, for example, FIG. 29. The user information table stores a user ID, which the server 100 issues to the user, who performed a predetermined registration procedure, a telephone number of the mobile terminal 200 possessed by the user, folding status of the mobile terminal 200, and a genre of information designated by the user to be associated with one another as illustrated in FIG. 29.

Moreover, it is assumed that the provision information DB 140 of the server 100 stores information (news, etc.) divided into, for example, various genres provided by the user. These pieces of information are periodically updated by the manager of the server 100 and maintained to be always the latest information.

An explanation is next given of an operation of a mobile network system according to the present embodiment.

A user who uses an information provision service provided by the server 100, operates the input section 260 of the mobile terminal 200 to gain access to the server 100 and perform a predetermined registration procedure, similar to the third embodiment.

Through the registration procedure, the control section 110 of the server 100 issues a user ID to the user and stores information relating to the user, who performed the registration procedure, in a user information table stored in the user information DB 130. Then, the control section 110 supplies the issued user ID and a status transmission program for automatically transmitting the folding state of the mobile terminal 200 to the server 100 to the mobile terminal 200 of the user, who performed the registration procedure.

The control section 210 of the mobile terminal 200 possessed by the user who performed the registration procedure, stores the user ID supplied from the server 100 and the status transmission program in the program storing section 240.

Moreover, the user who is registered in the server 100, operates the input section 260 of the mobile terminal 200, so that the user can designate desired multiple genres. The control section 110 of the server 100 stores genres (economic news, sports news, entertainment news, and/or weather forecast, etc.) designated by the user in the genres of the user information table stored in the user information DB 130.

The user who performed the registration procedure, unfolds the mobile terminal 200 possessed by the user, so that the message service provided by the server 100 can be used. Moreover, according to the user's action of folding the mobile terminal 200, the use of the information provision service provided by the server 100 can be stopped (interrupted).

When the user unfolds the mobile terminal 200, the folding detecting section 280 of the mobile terminal 200 detects that the mobile terminal 200 is unfolded and outputs an unfold signal, which indicates that the mobile terminal 200 is unfolded, to the control section 210.

In response to the fold signal supplied from the folding state detector 280, the control section 210 transmits the fold signal to the server 100 together with the user ID stored in the user information storing section 230 according to a status transmission program of the program storing section 240.

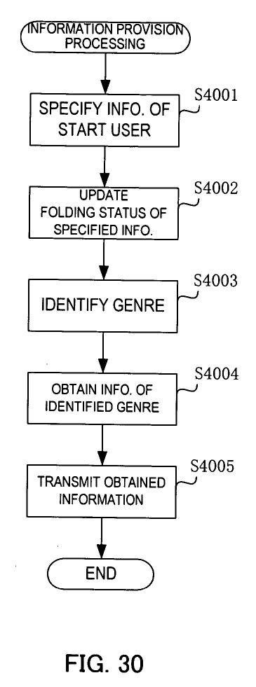

In response to the fold signal supplied from the mobile terminal 200, the control section 110 of the server 100 starts information provision processing illustrated in FIG. 30 according to a program of the program storing section 180.

First, the control section 110 specifies information of a user (start user) who starts the use of the information provision service, from the user information table stored in the user information DB 130 using the user ID supplied together with the fold signal (step S4001).

Then, the control section 110 updates folding status included in the specified start user (step S4002). More specifically, the control section 110 rewrites the folding status of the start user from “fold” to “unfold.”

Sequentially, the control section 110 identifies a genre included in information of the specified start user (step S4003).

Then, the control section 110 obtains information of the identified genre from the user information DB 130 (step S4004), and transmits it to the mobile terminal 200 of the start user via the communications control section 120 (step 4005).

In response to the information supplied from the server 100, the control section 210 of the mobile terminal 200 controls the output section 170 to display supplied information and output it as a voice. This makes it possible for the start user to obtain information of a desired genre.

Next, when the user folds the mobile terminal 200, the folding state detector 280 of the mobile terminal 200 detects that the mobile terminal 200 is folded, and outputs a fold signal indicating that the mobile terminal 200 is folded to the control section 210.

In response to the fold signal supplied from the folding state detector 280, the control section 210 transmits the fold signal to the server 100 together with the user ID stored in the user information storing section 230 according to a status transmission program of the program storing section 240.

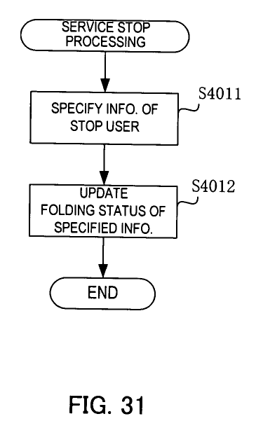

In response to the fold signal supplied from the mobile terminal 200, the control section 110 of the server 100 starts service stop processing illustrated in FIG. 31 according to a program of the program storing section 180.

First, the control section 110 specifies information of a user (stop user) who stops the use of the information provision service, from the user information table stored in the user information DB 130 using the user ID supplied together with the fold signal (step 4011).

Then, the control section 110 updates folding status included in information of the specified stop user (step S4012). More specifically, the control section 110 rewrites the folding status of the stop user from “unfold” to “fold.”

As mentioned above, the user merely folds the mobile terminal 200 to make it possible to stop the use of the information provision service provided by the server 100.

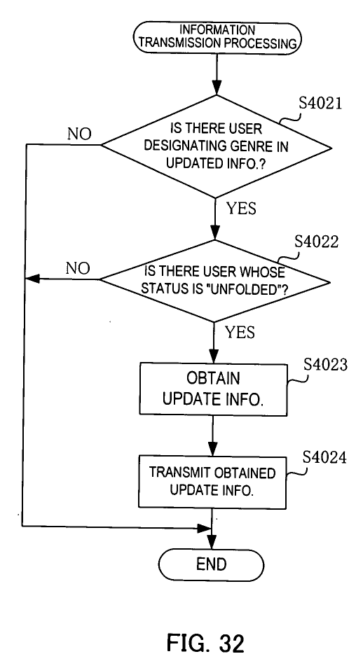

Moreover, when updating information stored in the user information DB 130, the control section 110 of the server 100 may execute information transmission processing illustrated in FIG. 32.

First, the control section 110 identifies a genre of the updated information, and searches the user information table of the user information DB 130 to determine whether there is a user, who designates the identified genre (step S4021).

If it is determined that there is no user, who designates the identified genre (step S4021: No), the control section 110 ends information transmission processing.

On the other hand, if it is determined that there is a user who designates the identified genre (step S4021: Yes), the control section 110 determines whether there is a user whose folding status is “unfold” in the users, who designate the identified genre, with reference to the folding status of the user information table (step S4022). Accordingly, it is possible to determine whether there is a user, who is in a status where the information provision service can be received, in the users, who designate the identified genre.

If it is determined that there is no user whose folding status is “unfold” (step S4022: No), the control section 110 terminates information transmission processing.

On the other hand, if it is determined that there is a user whose folding status is “unfold” (step S4022: Yes), the control section 110 obtains updated information from the user information DB 130 (step S4023).

Then, the control section 110 transmits obtained information to the mobile terminal 200 of the user, who designates the genre of the updated information, whose folding status is “unfold” (step S4024), and terminates information transmission processing.

The control section 210 of the mobile terminal 200 to which the updated information is supplied controls the output section 170 to display the supplied information and output it as a voice. In this way, the user can always obtain the latest information if a desired genre is pre-designated.

Additionally, the control section 210 of the mobile terminal 200 may transmit an unfold signal in response to a user's instruction. More specifically, the user may unfold the mobile terminal 200 to depress a predetermined button of the input section 260 if the user wishes to use the service provided by the server 100. In response to the depression of the predetermined button, the input section 260 may output a transmission signal instructing transmission of the unfold signal to the control section 210. In response to the transmission signal from the input section 260, the control section 210 may transmit the unfold signal to the server 100 together with the user ID stored in the user information storing section 230. In this way, the user can receive the service provided by the server 100 when the user wishes.

In the aforementioned third embodiment and fourth embodiment, an explanation was given using a cellular phone as an example. However, the present invention can be applied to a mobile terminal such as a PDA (Personal Digital Assistant), a notebook personal computer even if those have the folding structure.

Moreover, the server 100 of each embodiment can be configured by, for example, a general-purpose computer apparatus such as a personal computer and the like in addition to a dedicated apparatus. In this case, part or entire program for implementing each processing is installed onto the general-purpose computer and executed under control of OS, thereby making it possible to configure the server 100. In this case, any program distribution format may be possible. For example, the program can be distributed after being stored in a storage medium such as CD-ROM and the like, and the program is superimposed on a carrier wave to make it possible to distribute the program via communication media (Internet, etc.).

### INDUSTRIAL APPLICABILITY

The present invention can be effectively used as a server to a mobile terminal such as a cellular phone, etc.

This application is based on Japanese Patent Application 2002-129243 filed on Apr. 30, 2002, Japanese Patent Application 2002-145647 filed on May 21, 2002, and Japanese Patent Application 2002-236299 filed on Aug. 14, 2002 and including specification, claims, drawings and summary. The disclosure of the above Japanese Patent Application is incorporated herein by reference in its entirety.

1-11. (canceled)

12. A mobile terminal server, which is a mobile terminal server that controls a mobile terminal by way of a communications network, comprising:
a job priority information storing section that stores job ranking information indicating a priority of jobs executed by the mobile terminal; and
a terminal control section that causes the mobile terminal to execute the job according to the priority indicating the job ranking information.

13. The mobile terminal server according to claim 12, further comprising a status information obtaining section that obtains status information indicating a job execution status of the mobile terminal,
wherein the terminal control section causes the mobile terminal to execute the job according to the priority indicated by the status information and the job ranking information.

14. The mobile terminal server according to claim 13,
wherein the terminal control section includes:
a first determining section that responds to an execution request of a job supplied from an external section to determine whether the mobile terminal is executing a job with a lower priority than a request job requested to be executed by the execution request using the job ranking information and the status information; and
a first control section that controls the mobile terminal to interrupt execution of the lower job and execute the request job when determining that the mobile terminal is executing the low job.

15. The mobile terminal server according to claim 14, wherein the first control section responds to an end signal indicating an end of the request job supplied from the mobile terminal to cause the mobile terminal to restart execution of the lower job that is interrupted to be executed.

16. The mobile terminal server according to claim 15, wherein the terminal control section further includes:
a second determining section that responds to an execution request of a job supplied from an external section to determine whether the mobile terminal is executing a job with a higher priority than a request job requested to be executed by the execution request using the job ranking information and the status information; and
a second control section that responds to an end signal indicating an end of the higher job supplied from the mobile terminal and causes the mobile terminal to execute the request job when determining that the mobile terminal is executing the high job.

17. The mobile terminal server according to claim 14, wherein the terminal control section further includes:
a second determining section that responds to an execution request of a job supplied from an external section to determine whether the mobile terminal is executing a job with a higher priority than a request job requested to be executed by the execution request using the job ranking information and the status information; and
a second control section that responds to an end signal indicating an end of the higher job supplied from the mobile terminal and causes the mobile terminal to execute the request job when determining that the mobile terminal is executing the high job.

18. A program causing a computer to function as the mobile terminal server recited in claim 12.

19. A mobile terminal server that exchanges information with multiple mobile terminals by way of a communications network, comprising:
an open/close status information storing section that stores open/close status information indicating an open/close status of the multiple mobile terminals; and
a transmitting section that responds to an open signal supplied from one mobile terminal and indicating that the relevant mobile terminal is opened, and obtains an open/close status of the other mobile terminal predesignated as an open/close status notifying object, and transmits the result to one mobile terminal.

20. The mobile terminal server according to claim 19, wherein the transmitting section responds to the open signal and a close signal supplied from one mobile terminal and indicating that the relevant mobile terminal is closed, updates open/close information stored in the open/close information storing section, and transmits open/close information indicating an open/close status of one mobile terminal to a predetermined other mobile terminal.

21. The mobile terminal server according to claim 20, further comprising a storing section that stores information divided into multiple genres, wherein the transmitting section responds to the open signal supplied from the mobile terminal and indicating that the relevant mobile terminal is opened, and transmits information of a predetermined genre to the relevant mobile terminal from information of the multiple genres stored in the storing section.

22. The mobile terminal server according to claim 19, further comprising a storing section that stores information divided into multiple genres, wherein the transmitting section responds to the open signal supplied from the mobile terminal and indicating that the relevant mobile terminal is opened, and transmits information of a predetermined genre to the relevant mobile terminal from information of the multiple genres stored in the storing section.

23. A program causing a computer to function as the mobile terminal server recited in claim 19.

24. A mobile terminal server that exchanges information with multiple mobile terminals by way of a communications network, comprising:
an open signal receiving section that receives an open signal supplied from each of multiple mobile terminals and indicating that the relevant mobile terminal is opened; and
a transmitting section that responds to the open signal received by the open signal receiving section and transmits predetermined information to the mobile terminal.

25. The mobile terminal server according to claim 24, further comprising:
an information storing section that stores information divided into multiple genres;
wherein the transmitting section responds to reception of the open signal and transmits information of a predetermined genre from information stored in the information storing section to the mobile terminal.

26. A computer program causing a computer to function as the mobile terminal server or the mobile terminal defined claim 24.

27. An openable/closable mobile terminal that exchanges information with other mobile terminal by way of a communications network, comprising:
a job executing section that executes a job;
a transmitting section that transmits a status signal indicating a job execution status to another apparatus; and
a job control section that controls the job executing section to stop execution of a first job having a first level of priority and being executed by the job executing section, and execute a second job having a second level of priority higher than the first level instructed from the other apparatus and restart the interrupted first job after ending the second job according to control from the other apparatus.

28. A computer program causing a computer to function as the mobile terminal server or the mobile terminal defined claim 27.

29. An openable/closable mobile terminal that exchanges information with other mobile terminal by way of a communications network, comprising:
an open/close detecting section that detects that the mobile terminal is opened; and
a transmitting section that transmits an open signal for notifying the open to the other apparatus when the open/close detecting section detects that the mobile terminal is opened.

30. The mobile terminal according to claim 29, further comprising:
a receiving section that receives information transmitted from the other apparatus in response to the open signal; and
an outputting section that outputs information received by the receiving section.

31. The mobile terminal according to claim 30,
wherein information transmitted from the other apparatus in response to the open signal includes a signal indicating an open/close status of the other mobile terminal; and
wherein the outputting section outputs information indicating an open/close status of the other mobile terminal.

32. The mobile terminal according to claim 29, wherein the transmitting section includes a section that transmits a close signal indicating that the mobile terminal is closed to the other apparatus in response to detection of the open/close detecting section.

33. A computer program causing a computer to function as the mobile terminal server or the mobile terminal defined claim 29.
